(19) United States
(12) Patent Application Publication
(10) Pub. No.: US 2015/0349667 A1
(43) Pub. Date: Dec. 3, 2015

(54) INTERNAL VIBRATION IMPULSED BROADBAND EXCITATION ENERGY HARVESTER SYSTEMS AND METHODS

(71) Applicant: MicroGen Systems, Inc., West Henrietta, NY (US)

(72) Inventors: Robert G. Andosca, Fairport, NY (US); John Andosca, Fairport, NY (US); Junru Wu, South Burlington, VT (US)

(21) Appl. No.: 14/290,425

(22) Filed: May 29, 2014

(51) Int. Cl. H02N 2/18

(52) U.S. Cl. CPC H02N 2/188; H02N 2/181

(57) ABSTRACT

The present invention relates to an energy harvester system. The energy harvester system includes an energy harvester device, a housing comprising internal walls surrounding at least a portion of the energy harvester device, and a flexible supporting structure supporting the energy harvester device within the housing. Movement of the housing causes the internal walls of the housing, or structures connected to the internal walls, to contact the energy harvester device, whereby the flexible supporting structure and the energy harvester device move such that the energy harvester device contacts the internal walls or structures connected to the internal walls at least one additional time (or multiple times), thereby producing energy. Also disclosed is a system comprising an electrically powered apparatus and the energy harvester system of the present invention electrically coupled to the apparatus. The present invention further relates to a method of powering an electrically powered apparatus with the energy harvester system of the present invention.

### FIELD OF THE INVENTION

The present invention relates to internal vibration impulsed broadband excitation energy harvester systems and methods of their use.

### BACKGROUND OF THE INVENTION

Vibrational energy harvester devices offer electrical power generation in environments that lack light, air movement, and temperature gradients. Instead, vibrations and or movements, e.g., emanating from a structural support, which can be in the form of either a vibration at a constant frequency, or an impulse vibration containing a multitude of frequencies can be scavenged (or harvested) to convert movement (e.g., vibrational energy) into electrical energy. One particular type of vibrational energy harvester utilizes resonant beams that incorporate a piezoelectric material that generates electrical charge when strained during movement of the beams caused by ambient vibrations (driving forces), such as that described in U.S. patent application Ser. No. 14/173,131 to Vaeth et al.

Improvements are needed in the energy harvesting capabilities of such devices. Existing devices rely on excitation of the cantilevered stacked piezoelectric beam with either or both low frequency and high frequency motion type inputs. Power generation is maximized when the unit is vibrating at resonant frequencies, driven by a single fixed frequency matching the resonant frequency of the harvester. However, kinetic inputs found in ambient and high intensity energy environments may not be at a single fixed frequency, or may not be matched to the resonant frequency of the beam and, therefore, may not be sufficient to excite the resonant mode of piezoelectric energy harvesters, resulting in lost efficiency. Even if not excited continuously in time at its resonant frequency, the vibrational energy harvester will still respond to kinetic inputs or impulses from the environment, and exhibit a ring down behavior characterized by an exponential decay in displacement amplitude, which will also generate energy. It is important to note that this “impulse mode” of operation will produce less power than if the harvester were excited into resonant mode driven by a fixed frequency in time matched to the natural frequency of the device, as the displacement in impulse mode is less than in resonant mode, and the displacement decays exponentially at a rate proportional to the damping coefficient of the harvester, as opposed to resonant mode, where the displacement amplitude does not decay. After sufficient decay in peak amplitude has taken place (as characterized by the damping coefficient), not much power is produced from the harvester, and it would be advantageous to stimulate the harvester again, in order to maximize power output.

The present invention is directed to overcoming these and other deficiencies in the art.

### SUMMARY OF THE INVENTION

One aspect of the present invention relates to an energy harvester system. The energy harvester system includes an energy harvester device comprising an elongate resonator beam comprising a piezoelectric material, the resonator beam extending between first and second ends. The energy harvester system further includes a housing comprising internal walls surrounding at least a portion of the energy harvester device and a flexible supporting structure supporting the energy harvester device within the housing. Movement of the housing causes its internal walls, or structures connected to its internal walls, to contact the energy harvester device, whereby the flexible supporting structure and the energy harvester device move such that the energy harvester device contacts the internal walls or structures connected to the internal walls at least one additional time, thereby producing energy.

Another aspect of the present invention relates to a system comprising an electrically powered apparatus and the energy harvester system of the present invention electrically coupled to the apparatus.

A further aspect of the present invention relates to a method of powering an electrically powered apparatus. This method involves providing the energy harvester system of the present invention. The energy harvester system is subjected to movement to generate electrical energy from the piezoelectric material. The electrical energy is transferred from the piezoelectric material to the electrically powered apparatus to provide power to the apparatus.

In the present invention, an alternative method of exciting a cantilevered beam system with shock-like inputs (where shock-like inputs are excitations not continuously fixed at the natural resonant frequency of the vibrational harvester) to the energy harvester device under loading conditions is provided. Normal kinetic motion input sources can produce shock-like input responses such as those due to vibration and jarring. These shocks can be regular in frequency, but not matched to the resonant frequency of the harvester, or variable in frequency and duration. However, these types of shock-like inputs may be inadequate to fully maximize energy harvesting power generation, because they are not matched to the natural resonant frequency of the resonator beam of the energy harvester device and do not enable it to enter a resonant mode of operation. Therefore, the present invention is directed to an energy harvester system that generates excitation of the harvester device under all motion input types to maximize power generation. The present invention is directed to a new type of energy harvester system that accounts for easy integration into many application domains, including high intensity energy environments.

The key to maximizing power generation in the energy harvester system of the present invention is to provide at least one additional shock, and more preferably, multiple shocks to the energy harvester device component per each external shock-like impulse input to the energy harvester system. This increases the number of shocks experienced by the energy harvester device component over the number of shock-like inputs from the environment, increasing the power output. The energy harvester system of the present invention has the ability to produce AC power when impulsed. The feasibility of using this new type of energy harvester system with design links to previously proven and validated technology (e.g., MEMS piezoelectric energy harvester devices) allows capable integration within many application domains, including high intensity energy environments.

### BRIEF DESCRIPTION OF THE DRAWINGS

FIGS. 1A-1C illustrate various embodiments of an energy harvester system of the present invention. FIG. 1A is an elevational side view of the energy harvester system, which includes an energy harvester device, a housing comprising internal walls surrounding the energy harvester device, and a flexible supporting structure supporting the energy harvester device within the housing. FIG. 1B is a top view of one particular embodiment of the flexible supporting structure(s) and energy harvester device components of the energy harvester system of FIG. 1A (with the housing removed) showing four different flexible supporting structures (or four regions of a single flexible supporting structure) emanating from four corners of the energy harvester device to attach to a housing. FIG. 1C is a top view of another particular embodiment of the flexible supporting structure(s) and energy harvester device components of the energy harvester system of FIG. 1A (with the housing removed) showing three different flexible supporting structures (or three regions of a single flexible supporting structure) emanating from three different locations of the energy harvester device to attach to a housing.

FIGS. 2A-D are different views of one embodiment of an energy harvester device component of the energy harvester system of the present invention. The energy harvester device includes an elongate resonator beam comprising a piezoelectric material, the resonator beam extending between first and second ends; a base connected to the resonator beam at the first end with the second end being freely extending from the base as a cantilever; and a mass attached to the second end of the resonator beam. FIG. 2A is a side view of the energy harvester device, showing one embodiment of a base, which surrounds on four sides a resonator beam connected to the base. FIG. 2B is a partial cut-away, side view of the energy harvester device with portions of the base cut away along section 2B shown in FIG. 2D to show side views of the resonator beam and mass that form the energy harvester device. FIG. 2C is a perspective view of the energy harvester device, which illustrates the elongate resonator beam, the base, and the mass. FIG. 2D is a top view of the energy harvester device, which illustrates the elongate resonator beam, the base, and the mass.

FIGS. 3A-D illustrate various other embodiments of an energy harvester system of the present invention. FIG. 3A is an elevational side view of the energy harvester system, which includes an energy harvester device, a housing comprising internal walls surrounding the energy harvester device, and a flexible supporting structure supporting the energy harvester device within the housing. FIG. 3B is a top view of one particular embodiment of the flexible supporting structure(s) and energy harvester device components of the system of FIG. 3A (with the housing removed) showing four different flexible supporting structures (or four regions of a single flexible supporting structure) emanating from a central plate supporting the energy harvester device to attach to a housing. FIG. 3C is a top view of another particular embodiment of the flexible supporting structure(s) and energy harvester device components of the system of FIG. 3A (with the housing removed) showing four different flexible supporting structures (or four regions of a single flexible supporting structure) emanating from a central plate supporting the energy harvester device to attach to a housing. FIG. 3D is a top view of another particular embodiment of the flexible supporting structure(s) and energy harvester device components of the energy harvester system of FIG. 3A (with the housing removed) showing three different flexible supporting structures (or three regions of a single flexible supporting structure) emanating from three different locations of a central plate supporting the energy harvester device to attach to a housing.

FIG. 4 is an elevational side view of one embodiment of an energy harvester system of the present invention, which includes an energy harvester device, a housing comprising internal walls surrounding the energy harvester device, and a flexible supporting structure supporting the energy harvester device within the housing. In the particular embodiment illustrated in FIG. 4, the flexible supporting structure(s) supports the energy harvester device from above the device, or the energy harvester device is attached to a lower surface of the flexible supporting structure.

FIGS. 5A-C illustrate various other embodiments of an energy harvester system of the present invention. FIG. 5A is an elevational side view of the energy harvester system, which includes an energy harvester device, a housing comprising internal walls surrounding the energy harvester device, and a flexible supporting structure supporting the energy harvester device within the housing. In this particular embodiment, the flexible supporting structure supports the energy harvester device from less than all sides of the energy harvester device. FIG. 5B is a top view of one particular embodiment of the flexible supporting structure(s) and energy harvester device components of the system of FIG. 5A (with the housing removed) showing two different flexible supporting structures (or two regions of a single flexible supporting structure) emanating from one side of the energy harvester device to attach to a housing. FIG. 5C is a top view of another particular embodiment of the flexible supporting structure(s) and energy harvester device components of the system of FIG. 5A (with the housing removed) showing a single flexible supporting structure emanating from one side of the energy harvester device to attach to a housing.

FIGS. 6A-D illustrate various other embodiments of an energy harvester system of the present invention. FIG. 6A is an elevational side view of the energy harvester system, which includes an energy harvester device, a housing comprising internal walls surrounding the energy harvester device, and a flexible supporting structure supporting the energy harvester device within the housing. In this particular embodiment, the energy harvester device is supported by at least two flexible supporting structures (or two regions of a single flexible supporting structure), one above the energy harvester device and one below the energy harvester device. FIG. 6B is a top view of one particular embodiment of the flexible supporting structure(s) and energy harvester device components of the energy harvester system of FIG. 6A (with the housing removed) showing a single flexible supporting structure attached to the central, upper surface of the energy harvester device to attach to a housing. A corresponding flexible supporting structure (or flexible supporting structure region) is located on the lower surface of the energy harvester device component to attach to the housing. FIG. 6C is a top view of another particular embodiment of the flexible supporting structure(s) and energy harvester device components of the energy harvester system of FIG. 6A (with the housing removed) showing a single flexible supporting structure attached at or near the upper surface (on one side) of the energy harvester device to attach to a housing. A corresponding flexible supporting structure (or flexible supporting structure region) is located on the lower surface of the energy harvester device component to attach to the housing. FIG. 6D is a top view of another particular embodiment of the flexible supporting structure(s) and energy harvester device components of the energy harvester system of FIG. 6A (with the housing removed) showing two flexible supporting structures (or two regions of a single flexible supporting structure) attached to opposing sides of the energy harvester device to attach to a housing.

FIGS. 7A-C illustrate various other embodiments of an energy harvester system of the present invention. FIG. 7A is an elevational side view of the energy harvester system, which includes an energy harvester device, a housing comprising internal walls surrounding the energy harvester device, and a flexible supporting structure supporting the energy harvester device within the housing. The energy harvester device is supported by at least four flexible supporting structures (or four regions of a single flexible supporting structure), two above the energy harvester device and two below the energy harvester device. FIG. 7B is a top view of one particular embodiment of the flexible supporting structure(s) and energy harvester device components of the energy harvester system of FIG. 7A (with the housing removed) showing four flexible supporting structures (or four flexible supporting structure regions) attached to four corners of the upper surface of the energy harvester device component to attach to a housing. Corresponding flexible supporting structures (or flexible supporting structure regions) are located on the lower surface of the energy harvester device component to attach to the housing. FIG. 7C is a top view of one particular embodiment of the flexible supporting structure(s) and energy harvester device components of the energy harvester system of FIG. 7A (with the housing removed) showing three flexible supporting structures (or three flexible supporting structure regions) attached at three different locations of the upper surface of the energy harvester device component to attach to a housing. Corresponding flexible supporting structures (or flexible supporting structure regions) are located on the lower surface of the energy harvester device component to attach to the housing.

FIG. 8 is an elevational side view of one embodiment of an energy harvester system of the present invention, which includes an energy harvester device, a housing comprising internal walls surrounding the energy harvester device, and a flexible supporting structure supporting the energy harvester device within the housing. In the particular embodiment illustrated in FIG. 8, the flexible supporting structure(s) supports the energy harvester device from the upper surface of the device at a location central to at least two opposing sides of the energy harvester device component. Various other embodiments of how this may be achieved are illustrated in FIGS. 6B-6D.

FIG. 9 is an elevational side view of one embodiment of an energy harvester system of the present invention, which includes an energy harvester device, a housing comprising internal walls surrounding the energy harvester device, and a flexible supporting structure supporting the energy harvester device within the housing. In the particular embodiment illustrated in FIG. 9, the flexible supporting structure(s) supports the energy harvester device from the upper surface of the device from at least two opposing sides of the energy harvester device component. Various other embodiments of how this may be achieved are illustrated in FIGS. 7B-7C.

FIGS. 10A-D are elevational side views of one embodiment of an energy harvester system of the present invention which illustrate the operation of the energy harvester system upon movement of the housing. Movement of the housing caused by an external impulse (FIG. 10A) causes the internal walls of the housing to contact the energy harvester device (FIG. 10B). The flexible supporting structure(s) and the energy harvester device move such that the energy harvester device contacts the internal walls at least one additional time (FIG. 10C), thereby producing energy. Additional movement of the flexible supporting structure(s) and the energy harvester device can result in additional contacts between the energy harvester device and the internal walls (FIGS. 10C and 10D), thereby producing additional energy.

FIGS. 11A-11B are graphs illustrating two different embodiments of electrical ringdown of energy harvester systems. FIG. 11A illustrates the electrical ringdown of an energy harvester device or system according to the prior art, which shows a voltage output to only a single external impulse. FIG. 11B illustrates the electrical ringdown of an energy harvester system according to one embodiment of the present invention, which shows a voltage output to a single external impulse, which causes the energy harvester to hit the inner walls of the housing multiple additional times, generating more voltage. With multiple additional impulses (three in this example), the average voltage output from an energy harvester system according to the present invention is higher, making the power, on average, higher.

FIGS. 12A-D are elevational side views of one embodiment of an energy harvester system of the present invention which illustrate the operation of the energy harvester system upon movement of the housing. Movement of the housing caused by an external impulse (FIG. 12A) causes structures on the internal walls of the housing to contact the energy harvester device (FIG. 12B). The flexible supporting structure(s) and the energy harvester device move such that the energy harvester device contacts the structures at least one additional time (FIG. 12C), thereby producing energy. Additional movement of the flexible supporting structure(s) and the energy harvester device can result in additional contacts between the energy harvester device and the structures on the internal walls (FIGS. 12C and 12D), thereby producing additional energy.

FIGS. 13A-D are elevational side views of one embodiment of an energy harvester system of the present invention which illustrate the operation of the energy harvester system upon movement of the housing. Movement of the housing caused by an external impulse (FIG. 13A) causes the internal walls of the housing to contact structures on the energy harvester device (FIG. 13B). The flexible supporting structure(s) and the energy harvester device move such that the internal walls contact the structures on the energy harvester device at least one additional time (FIG. 13C), thereby producing energy. Additional movement of the flexible supporting structure(s) and the energy harvester device can result in additional contacts between the structures on the energy harvester device and the internal walls (FIGS. 13C and 13D), thereby producing additional energy.

FIGS. 14A-B illustrated a vented energy harvester device component (FIG. 14A) and a vented energy harvester system (FIG. 14B). In particular, FIG. 14A is a top view of one embodiment of the energy harvester device of the present invention with a base that encloses the resonator beam and the mass. Vent holes are formed in the upper surface of the base to reduce squeeze film damping in the energy harvester device. Corresponding vents may be present in the lower surface of the housing. FIG. 14B is an elevational side view of a vented housing of the energy harvester system of the present invention. Vent holes are formed in the side walls of the housing, and corresponding vents may be formed in other walls of the housing.

FIG. 15 is an elevational side view of one embodiment of the energy harvester system of the present invention which has two distinct chambers, including a first chamber in which the energy harvester device component and flexible supporting structure(s) reside and a second chamber in which a printed circuit board (“PCB”) resides. The PCB board is in electrical connection with energy harvester device and is capable of converting energy from the piezoelectric material from AC to DC power.

FIG. 16 is an elevational side view of one embodiment of the energy harvester system of the present invention illustrating an electrical port through which electrical connections exit the housing to connect to, e.g., a PCB board.

FIG. 17 is an elevational side view of one embodiment of the energy harvester system of the present invention in which the energy harvester device component is formed on or integral with a PCB board comprising energy harvesting circuitry and power conversion circuitry.

FIG. 18 is an elevational side view of another embodiment of the energy harvester system of the present invention in which the energy harvester device component is formed on or integral with a PCB board formed separate from energy harvesting circuitry and power conversion circuitry.

FIG. 19 is an exploded view of one embodiment of an energy harvester system of the present invention.

FIG. 20 is a perspective view of some of the components shown in FIG. 19, which are assembled.

FIG. 21 is a perspective view of the assembled energy harvester system shown in FIG. 19, formed into a power cell.

FIG. 22 illustrates one embodiment of a system of the present invention which includes an electrically powered smart phone containing an energy harvester system of the present invention which is electrically coupled to the smart phone to provide electrical energy to power the smart phone or to power a rechargeable battery contained therein.

FIGS. 23A-D illustrate two different embodiments of a system of the present invention in which a tire pressure monitoring system is electrically coupled to the energy harvester system of the present invention to power the tire pressure monitoring system. In the embodiment illustrated in FIGS. 23A-B, the system is located on the wheel rim, and in the embodiment illustrated in FIGS. 23C-D, the system is attached directly to the tire (e.g., underneath the tire tread).

FIG. 24 is an elevational side view of one embodiment of the energy harvester system of the present invention in which the energy harvester device component is a meso-scale energy harvester device containing an integrated mass.

FIG. 25 is an elevational side view of one embodiment of the energy harvester system of the present invention in which the energy harvester device component is a meso-scale energy harvester device.

FIGS. 26A-F are top views of various forms of flexible supporting structures of the system of the present invention.

### DETAILED DESCRIPTION OF THE INVENTION

The present invention relates to internal vibration impulsed broadband excitation energy harvester systems and methods of their use. The energy harvester systems of the present invention have improved energy harvesting capability by drawing from (i) kinetic inputs found in ambient and high intensity energy environments and (ii) kinetic energy motion inputs, including shock-like input responses under loading conditions.

One aspect of the present invention relates to an energy harvester system. The energy harvester system includes an energy harvester device comprising an elongate resonator beam comprising a piezoelectric material, the resonator beam extending between first and second ends. The energy harvester system further includes a housing comprising internal walls surrounding at least a portion of the energy harvester device and a flexible supporting structure supporting the energy harvester device within the housing. Movement of the housing causes its internal walls, or structures connected to its internal walls, to contact the energy harvester device, whereby the flexible supporting structure and the energy harvester device move such that the energy harvester device contacts the internal walls or structures connected to the internal walls at least one additional time, and more preferably, multiple times, thereby producing energy.

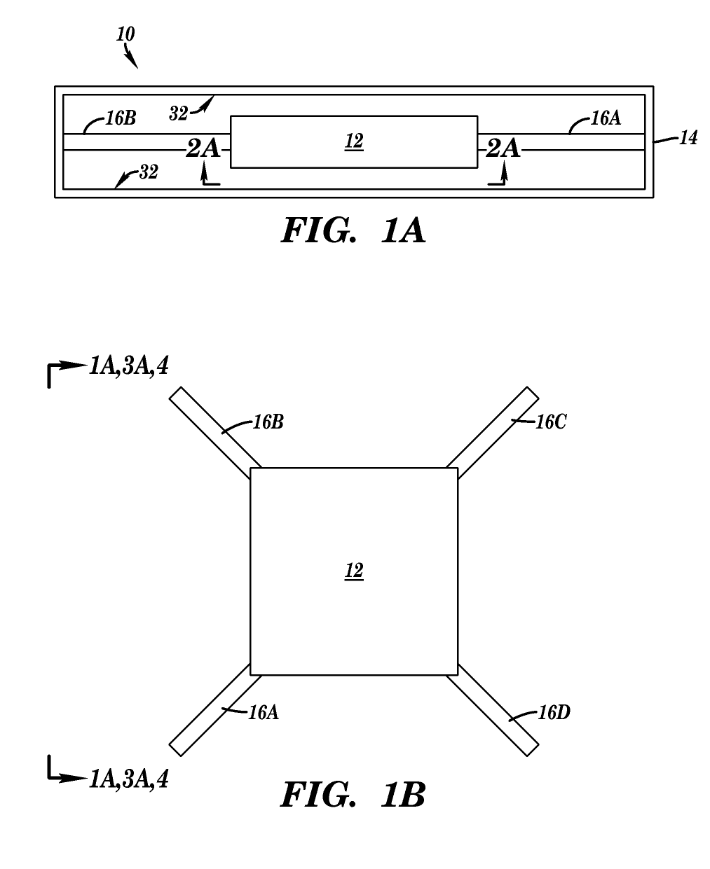

One embodiment of an energy harvester system of the present invention is illustrated in FIG. 1A. FIG. 1A is an elevational side view of energy harvester system 10, which includes energy harvester device 12, housing 14 comprising internal walls 32 surrounding energy harvester device 12, and flexible supporting structures (or flexible supporting structure portions) 16A and 16B supporting energy harvester device 12 within housing 14. In this particular embodiment, flexible supporting structures 16A and 16B support energy harvester device 12 from lateral opposing sides of energy harvester device 12. For example, flexible supporting structures 16A and 16B may be separate flexible supporting structures, each of which is connected to a separate location on opposing lateral sides of energy harvester device 12. Alternatively, flexible supporting structures 16A and 16B may be regions of a single flexible supporting structure formed around lateral edges of energy harvester device 12. FIG. 1B is a top view of one particular embodiment of the flexible supporting structure and energy harvester device components of energy harvester system 10 (with housing 14 removed). Specifically, energy harvester device 12 is supported by four different flexible supporting structures 16A, 16B, 16C, and 16D (or four regions 16A, 16B, 16C, and 16D of a single flexible supporting structure) emanating from the four corners of energy harvester device 12 to attach to a housing. When a single flexible supporting structure is used, e.g., with four emanating regions 16A, 16B, 16C, and 16D, the flexible supporting structure may have a plate-like structure underneath energy harvester device 12 and upon which energy harvester device 12 rests. This plate like structure would, according to one embodiment, be centrally located between emanating regions 16A, 16B, 16C, and 16D. FIG. 1C is a top view of another particular embodiment of the flexible supporting structure and energy harvester device components of energy harvester system 10 (with housing 14 removed). Specifically, energy harvester device 12 is supported by three different flexible supporting structures 16A, 16B, and 16C (or three regions 16A, 16B, and 16C of a single flexible supporting structure) emanating from three different locations of energy harvester device 12 to attach to a housing. The plate like structure can be made of the same material as the flexible supporting structure(s), or of different material.

In the energy harvester system of the present invention, the flexible supporting structure(s) may attach to the energy harvester device at any location on the energy harvester device. When an energy harvester device is fully enclosed in a package, the flexible supporting structure(s) may attach to the package at any one or more locations. Whatever the particular design of the attachment of the flexible supporting structure(s) to the energy harvester device, the attachment should not interfere with the movement of the resonator beam of the energy harvester device nor the ability of the energy harvester device to contact the inner housing walls or structures connected to the inner housing walls. According to one embodiment, the flexible supporting structure comprises a first end and a second end, the first end of the flexible supporting structure being attached to an interior wall of the housing and the second end of the flexible supporting structure being attached to an exterior surface of the energy harvester device.

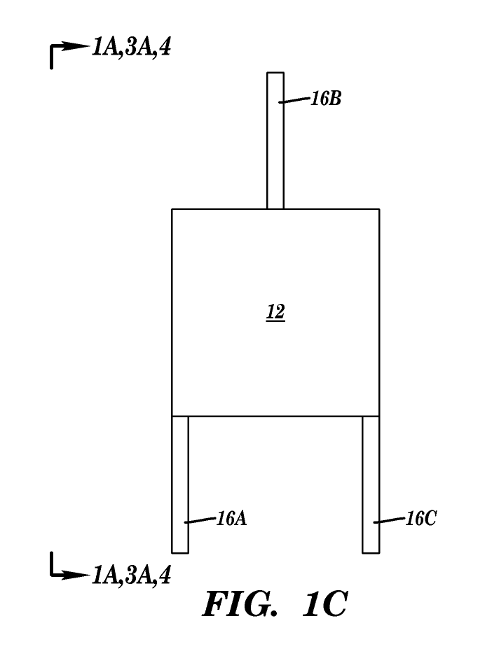

With reference now to FIGS. 2A-D, one embodiment of energy harvester device component suitable for the energy harvester system of the present invention is illustrated. Specifically, energy harvester device 12 includes elongate resonator beam 18 comprising a piezoelectric material. Resonator beam 18 extends between first end 20 and second end 22. Base 24 is connected to resonator beam 18 at first end 20 with second end 22 being freely extending from base 24 as a cantilever. Mass 26 is optional, but when present, is attached to second end 22 of resonator beam 18. FIG. 2A is a side view of energy harvester device 12, showing one embodiment of base 24, which surrounds on four sides the resonator beam connected to base 24. FIG. 2B is a partial cut-away, side view of energy harvester device 12 with portions of base 24 cut away along section 2B (shown in FIG. 2D) to show side views of resonator beam 18 and (optional) mass 26 that form energy harvester device 12. FIG. 2C is a perspective view of energy harvester device 12, which illustrates elongate resonator beam 18, base 24, and mass 26. FIG. 2D is a top view of energy harvester device 12, which illustrates elongate resonator beam 18, base 24, and mass 26.

Energy harvester device 12 may also include one or more electrodes 28 (see FIGS. 2C-D) in electrical contact with the piezoelectric material of resonator beam 18. According to one embodiment, electrodes 28 comprise a material selected from the group consisting of molybdenum and platinum, although other materials suitable for forming electrode structures may also be used. In addition, energy harvester device 12 may further include electrical harvesting circuitry 30 (see FIGS. 2C-D) in electrical connection with one or more electrodes 28 to harvest electrical energy from the piezoelectric material of resonator beam 18. As described in further detail below, electrodes 28 and/or electrical harvesting circuitry 30 may be electrically coupled to power conversion circuitry to convert energy from the piezoelectric material of resonator beam 18 (generated during motion of the energy harvester system, as described infra) from AC to DC power.

Resonator beam 18 of energy harvester device 12 comprises a piezoelectric material. Piezoelectric materials are materials that when subjected to mechanical strain become electrically polarized. The degree of polarization is proportional to the applied strain. Piezoelectric materials are widely known and available in many forms including single crystal (e.g., quartz), piezoceramic (e.g., lead zirconate titanate or PZT), thin film (e.g., sputtered zinc oxide), screen printable thick-films based upon piezoceramic powders (see, e.g., Baudry, “Screen-printing Piezoelectric Devices,” Proc. 6^{th} European Microelectronics Conference (London, UK) pp. 456-63 (1987) and White & Turner, “Thick-film Sensors: Past, Present and Future,” Meas. Sci. Technol. 8:1-20 (1997), which are hereby incorporated by reference in their entirety), and polymeric materials such as polyvinylidenefluoride (“PVDF”) (see, e.g., Lovinger, “Ferroelectric Polymers,” Science 220:1115-21 (1983), which is hereby incorporated by reference in its entirety).

Piezoelectric materials typically exhibit anisotropic characteristics. Thus, the properties of the material differ depending upon the direction of forces and orientation of the polarization and electrodes. The level of piezoelectric activity of a material is defined by a series of constants used in conjunction with the axes of notation. The piezoelectric strain constant, d, can be defined as

$$d = \frac{strain developed}{applied field} m \text{/} V$$

(Beeby et al., “Energy Harvesting Vibration Sources for Microsystems Applications,” Meas. Sci. Technol. 17:R175-R195 (2006), which is hereby incorporated by reference in its entirety).

In energy harvester device 12 of the present invention, resonator beam 18 has second end 22, which is freely extending from base 24 as a cantilever. A cantilever structure comprising piezoelectric material is designed to operate in a bending mode thereby straining the piezoelectric material and generating a charge from the d effect (Beeby et al., “Energy Harvesting Vibration Sources for Microsystems Applications,” Meas. Sci. Technol. 17:R175-R195 (2006), which is hereby incorporated by reference in its entirety). A cantilever provides low resonant frequencies, reduced further by the presence of mass 26 attached at second end 22 of resonator beam 18.

Resonant frequencies of resonator beam 18 of energy harvester device 12 in operation may include frequencies of about 50 Hz to about 4,000 Hz, about 100 Hz to about 3,000 Hz, about 100 Hz to about 2,000 Hz, or about 100 Hz to about 1,000 Hz.

According to one embodiment, resonator beam 18 comprises a laminate formed of a plurality of layers, at least one of which comprises a piezoelectric material. Suitable piezoelectric materials include, without limitation, aluminum nitride, zinc oxide, polyvinylidene fluoride (PVDF), and lead zirconate titanate based compounds. Other non-piezoelectric materials may also be used as layers along with a layer of piezoelectric material. Non-limiting examples of other layers include those described in U.S. patent application Ser. No. 14/173,131 to Vaeth et al., which is hereby incorporated by reference in its entirety. In one particular embodiment, the plurality of layers comprises at least two different materials.

Resonator beam 18 may have sidewalls that take on a variety of shapes and configurations to help tuning of resonator beam 18 and to provide structural support. According to one embodiment, resonator beam 18 has sidewalls which are continuously curved within the plane of resonator beam 18, as described in U.S. patent application Ser. No. 14/145,534 to Andosca & Vaeth, which is hereby incorporated by reference in its entirety.

Energy harvester device 12 includes mass 26 at second end 22 of resonator beam 18. However, mass 26 is optional. When present, mass 26 is provided to lower the frequency of resonator beam 18 and also to increase the power output of resonator beam 18 (i.e., generated by the piezoelectric material). Mass 26 may be constructed of a single material or multiple materials (e.g., layers of materials). According to one embodiment, mass 26 is formed of silicon wafer material. Other suitable materials include, without limitation, copper, gold, and nickel deposited by electroplating or thermal evaporation.

In one embodiment, a single mass 26 is provided per resonator beam 18. However, more than one mass 26 may also be attached to resonator beam 18. In other embodiments, mass 26 is provided, for example, at differing locations along resonator beam 18.

Energy harvester device 12 may be formed in an integrated, self-packaged unit. In particular, as illustrated in FIGS. 2A-B, package 24, which also forms the base to which first end 20 of resonator beam 18 is attached, is shown to surround the cantilever structure (i.e., resonator beam 18 and mass 26) so that it encloses (at least partially) the cantilever structure. In the present invention, the package can completely enclose the energy harvester device, or can be formed so as to vent the energy harvester device to the atmosphere. When it completely encloses the energy harvester device, the pressure within the enclosed package may be higher, equal to, or lower than atmospheric pressure. In one embodiment, the atmosphere in the enclosed package is less than atmospheric, for example, below 1 Torr.

In one embodiment, the package may further comprise a compliant stopper connected to the package (e.g., on an inside wall of the package), where the stopper is configured to stabilize motion of the cantilever to prevent breakage. Suitable compliant stoppers according to this embodiment of the energy harvester device are illustrated and described in U.S. patent application Ser. No. 14/173,131 to Vaeth et al., which is hereby incorporated by reference in its entirety. The compliant stopper of the energy harvester device may be constructed of a variety of materials. The stopper may be made compliant through material choice, design, or both material choice and design. According to one embodiment, the stopper is made from a material integral to the package. Suitable materials according to this embodiment may include, without limitation, glass, metal, silicon, oxides or nitrides from plasma-enhanced chemical vapor deposition (PECVD), or combinations thereof. According to another embodiment, the stopper is not integral to the package. Suitable materials for the stopper according to this embodiment may include, without limitation, glasses, metals, rubbers and other polymers, ceramics, foams, and combinations thereof. Other suitable materials for the compliant stopper include polymers with low water permeation, such as, but not limited to, cycloolefin polymers and liquid crystal polymers, or other injection molded polymers.

In an alternative embodiment, the resonator beam may be configured to have a stopper feature which is configured to stabilize motion of the cantilever. Suitable stopper features according to this embodiment are illustrated in U.S. patent application Ser. No. 14/145,560 to Andosca et al., which is hereby incorporated by reference in its entirety. According to this embodiment, a stopper is formed on the mass and/or the second end of the resonator beam, and is configured to prevent contact between the second end of the resonator beam and the package.

As those skilled in the art will readily appreciate, resonator beam 18 can be tuned by varying any one or more of a number of parameters, such as the cross-sectional shape of resonator beam 18, cross-sectional dimensions of resonator beam 18, the length of resonator beam 18, the mass of mass 26, the location of mass 26 on resonator beam 18, and the materials used to make resonator beam 18.

In operation, one or more electrodes harvest charge from the piezoelectric material of resonator beam 18 as resonator beam 18 is subject to movement (e.g., vibrational forces). Accordingly, electrodes 28 are in electrical connection with the piezoelectric material of resonator beam 18.

Electrical energy collected from the piezoelectric material of resonator beam 18 is then communicated to electrical harvesting circuitry 30. In one embodiment, electrical harvesting circuitry 30 is integrated with energy harvester device 12. In another embodiment, the electrical harvesting circuitry is not integrated with the energy harvester device. For example, the electrical harvesting circuitry may be a separate chip or board, or is present on a separate chip or board. The electrical harvesting circuitry can include power converter electronics for converting the AC signal to DC (described infra), or the power converter electronics can be separate circuitry.

Energy harvester device 12 of the energy harvester system of the present invention may be made in accordance with the methods set forth, e.g., in U.S. patent application Ser. No. 14/145,534 to Andosca & Vaeth; U.S. patent application Ser. No. 14/173,131 to Vaeth et al.; and U.S. patent application Ser. No. 14/201,293 to Andosca et al., which are hereby incorporated by reference in their entirety. For example, according to one embodiment, a method of producing an energy harvester device involves providing a silicon wafer having a first and second surface; depositing a first silicon dioxide (SiO₂) layer on the first surface of the silicon wafer; depositing a cantilever material on the first silicon dioxide layer; depositing a second silicon dioxide layer on the cantilever material; depositing a piezoelectric stack layer on the second silicon dioxide layer; patterning the piezoelectric stack layer; patterning the second silicon dioxide layer, the cantilever material, and the first silicon dioxide layer; and etching the second surface of the silicon wafer to produce the energy harvester device.

In an alternative embodiment, the energy harvester device component is a meso-scale energy harvester. For example, the energy harvester device may simply be a resonator beam constructed of piezoelectric material, optionally coupled on one or both sides (e.g., as a sandwich) by other materials, including, e.g., electrodes. Suitable meso-scale energy harvester devices according to this embodiment are commercially available from, e.g., Mide Technology Corp., Medford, Mass.

In the energy harvester system of the present invention, the housing (see, e.g., housing 14 of FIG. 1A) is constructed of a material selected from aluminum, steel, injection molded plastic, ceramic, glass, wood, or silicon-based materials.

According to one embodiment, the housing completely encloses the flexible supporting structure(s) and the energy harvester device components. According to another embodiment, the housing does not completely enclose the flexible supporting structure(s) and the energy harvester device components. As described in more detail infra, in one embodiment, the housing completely encloses the flexible supporting structure(s) and the energy harvester device components, but includes vents to expose the energy harvester device and flexible supporting structure(s) to atmospheric conditions.

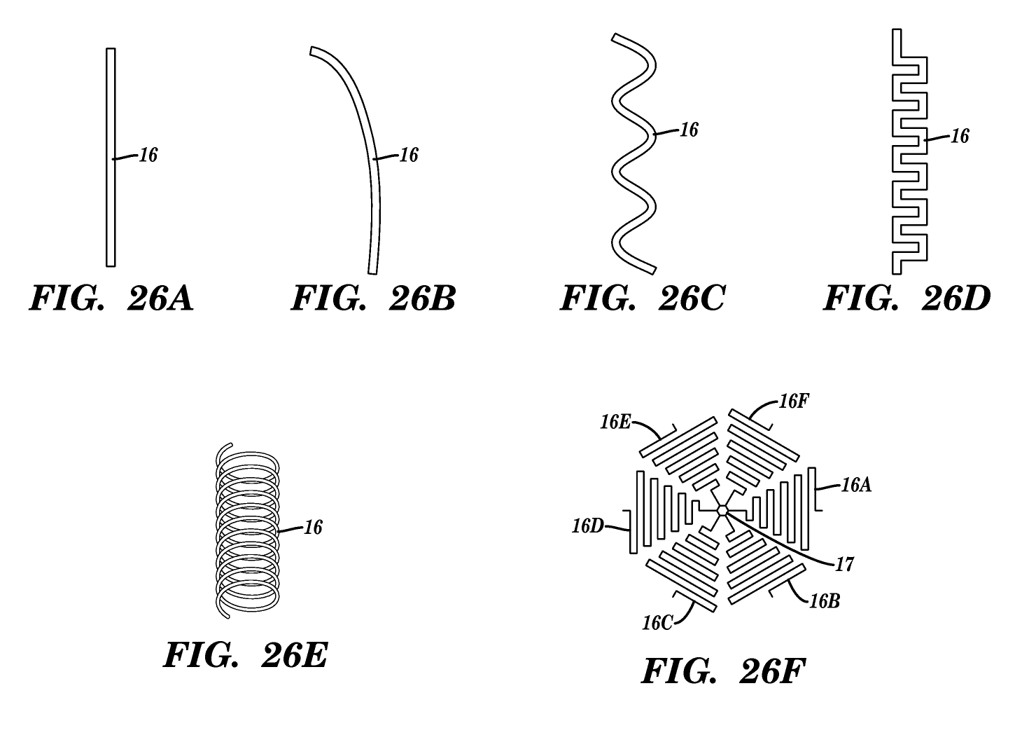

The flexible supporting structure component of the energy harvester system of the present invention may be constructed of a variety of materials, including, without limitation, metal, aluminum, steel, injection molded plastic, elastomer, plastic film, ceramic, glass, or silicon-based materials. The physical shape of the flexible supporting structure can also take on many forms, including strips, foils, films, helical coils, curved bars, and three dimensional and flat springs. Various shapes of suitable, but non-limiting, examples of flexible supporting structures are illustrated in FIGS. 26A-F. In FIGS. 26A-B, flexible supporting structures 16 take the form of a single tether, strip, or bar, which can be constructed of any of the above mentioned materials. In FIG. 26A, flexible supporting structure 16 is straight, and in FIG. 26B flexible supporting structure 16 is curved. In all of the examples shown in FIGS. 26A-F, the flexible supporting structure(s) has a first end and a second end, the first end of the flexible supporting structure being attachable to the interior wall(s) of the housing and the second end of the flexible supporting structure being attachable to either (i) a central supporting structure supporting an energy harvester device or (ii) directly to an energy harvester device. Flexible supporting structures 16 in FIGS. 26C-D have the physical shape of 2-dimensional flat springs. In FIG. 26E, flexible supporting structure 16 has the physical shape of a helical coil or a 3-dimensional spring. In FIG. 26F, flexible supporting structures 16A-F are in the form of MEMS flat springs, each connected at one end to central plate structure 17, which supports an energy harvester device.

The flexible support structures may be, according to one embodiment, a spring with a distinct resonance frequency, or a looser tether, as long as the flexible supporting structure(s) allow the energy harvester device it supports within the housing to move within the housing so as to maximize the number of impacts the energy harvester device has with the housing upon being subject to movement or impulse. In other words, the energy harvester device is not rigidly connected to the housing, but can contact any of the walls of the housing when subjected to an external impulse.

According to one embodiment, the flexible supporting structure is attached to the housing, e.g., one or more interior walls of the housing in one or more locations.

The energy harvester device component of the energy harvester system of the present invention may reside directly on, or be directly connected to, the flexible supporting structure(s). Alternatively, the energy harvester device component may be coupled to the flexible supporting structure via a plate. According to one embodiment, the energy harvester device component is coupled to the flexible supporting structure via a ceramic plate equipped with electrical leads to electrically connect the energy harvester device component to other components of the system. Other materials may also be used to couple the flexible supporting structure to the energy harvester device.

In one embodiment, the flexible supporting structure is connected to one or more lateral edges of the energy harvester device at between one and six locations on the one or more lateral edges.

In another embodiment, the flexible supporting structure comprises a central plate from which regions of the flexible supporting structure emanate to connect to the housing. According to this embodiment, the energy harvester device is supported by the central plate.

In the energy harvester system of the present invention, a single flexible supporting structure may be used, or multiple flexible supporting structures or flexible supporting structure-like elements may be used to support the energy harvester device. The energy harvester device may be attached (e.g., welded, soldered, glued, adhered) to the flexible supporting structure, or the flexible supporting structure may be attached (e.g., welded, soldered, glued, adhered) to the energy harvester device. In one embodiment, a single flexible supporting structure is used with a portion of the flexible supporting structure having a surface similar in size to the energy harvester device to accommodate attachment of the energy harvester device. In another embodiment, one or more flexible supporting structures are directly attached (at one or more sites) to the energy harvester device. This may be the case, e.g., when a meso-scale energy harvester device is used, as described supra. For example, the meso-scale energy harvester device may be clamped on one end of the resonator beam and the one or more flexible supporting structures may be attached directly to the clamped end or to a frame that includes the clamped end. In addition, the flexible supporting structure(s) may be the same or different in design or material. The number and/or particular design of the flexible supporting structure(s) will depend on the particular type and/or design of the energy harvester device and/or the use of the energy harvester system of the present invention. Various non-limiting embodiments of flexible supporting structure components and their attachment to the energy harvester device component in the energy harvester system of the present invention will now be described in further detail.

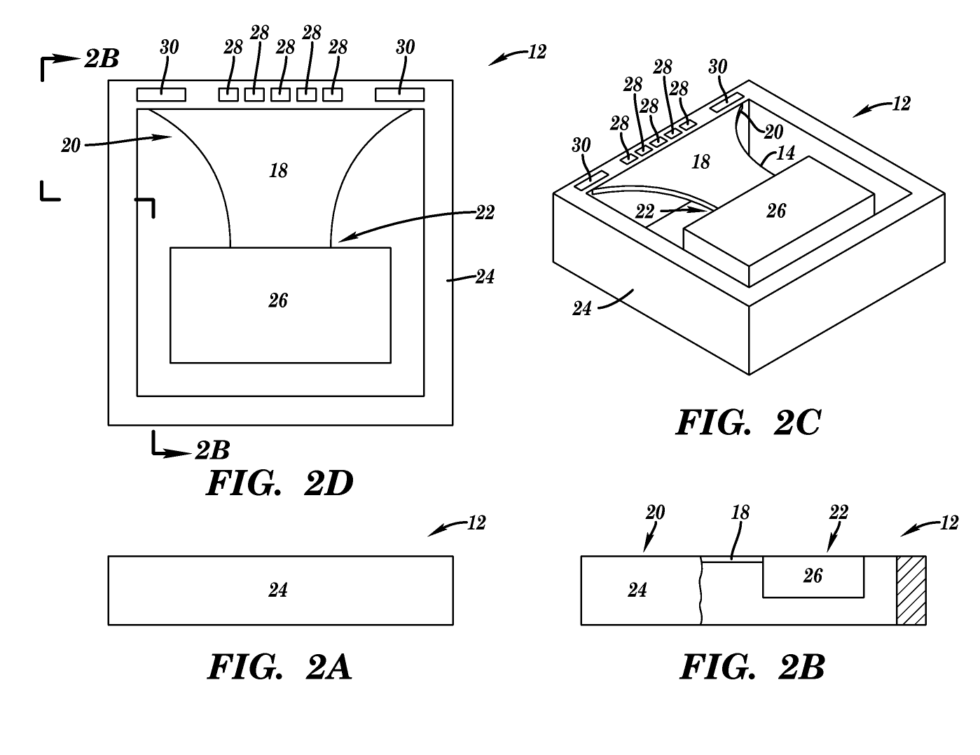

For example, various embodiments of an energy harvester system of the present invention are illustrated in FIGS. 3A-D. In particular, FIG. 3A is an elevational side view of energy harvester system 10, which includes energy harvester device 12, housing 14 comprising internal walls 32 surrounding energy harvester device 10, and visible flexible supporting structures 16A and 16B (or regions 16A and 16B of a single flexible supporting structure) supporting energy harvester device 12 within housing 14. In this particular embodiment, visible flexible supporting structures 16A and 16B support energy harvester device 12 from a lower surface of (i.e., underneath) energy harvester device 12. Visible flexible supporting structures 16A and 16B may be formed as a single flexible supporting structure with a central, flat surface to support energy harvester device 12, or may be separate structures separately connected to energy harvester device 12. FIG. 3B is a top view of one particular embodiment of the flexible supporting structure and energy harvester device components of energy harvester system 10 of FIG. 3A (with housing 14 removed). Specifically, energy harvester device 12 is supported by flexible supporting structures 16A, 16B, 16C, and 16D (or four regions 16A, 16B, 16C, and 16D of a single flexible supporting structure) emanating from energy harvester device 12 to attach to a housing. When a single flexible supporting structure is used, e.g., with four emanating regions 16A, 16B, 16C, and 16D, the flexible supporting structure may have plate-like structure 17 underneath (or above, according to other embodiments) energy harvester device 12 and upon which energy harvester device 12 rests (or is attached). Plate like structure 17 is, according to the illustrated embodiment, centrally located between emanating regions 16A, 16B, 16C, and 16D. FIG. 3C is a top view of another particular embodiment of the flexible supporting structure and energy harvester device components of energy harvester system 10 of FIG. 3A (with housing 14 removed). Specifically, energy harvester device 12 is supported by flexible supporting structures 16A, 16B, 16C, and 16D (or four regions 16A, 16B, 16C, and 16D of a single flexible supporting structure) emanating from plate-like structure 17 supporting energy harvester device 12 to attach to a housing. FIG. 3D is a top view of another particular embodiment of the flexible supporting structure and energy harvester device components of energy harvester system 10 of FIG. 3A (with housing 14 removed). Specifically, energy harvester device 12 is supported by three different flexible supporting structures 16A, 16B, and 16C (or three regions 16A, 16B, and 16C of a single flexible supporting structure) emanating from three different locations from plate-like structure (or region) 17 supporting energy harvester device 12 to attach to a housing.

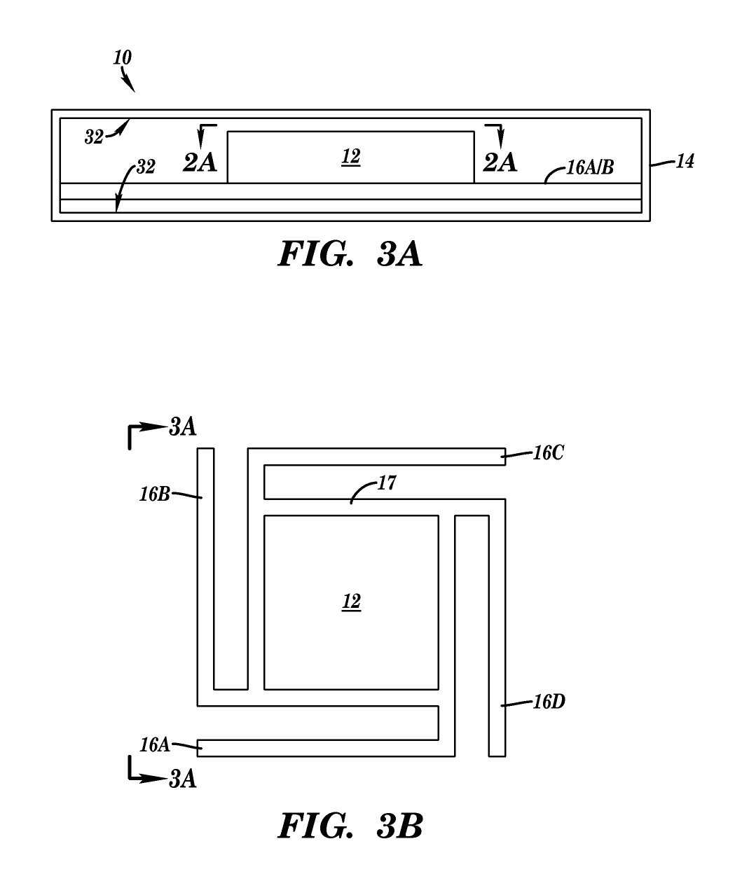

A further embodiment of an energy harvester system of the present invention is illustrated in FIG. 4. In particular, FIG. 4 is an elevational side view of one embodiment of energy harvester system 10 of the present invention, which includes energy harvester device 12, housing 14 comprising internal walls 32 surrounding energy harvester device 12, and flexible supporting structure(s) 16A/B supporting energy harvester device 12 within housing 14. In the particular embodiment illustrated in FIG. 4, flexible supporting structure(s) 16A/B support the energy harvester device from above (i.e., the upper surface of) energy harvester device 12, or energy harvester device 12 is attached to a lower surface of flexible supporting structure(s) 16A/B.

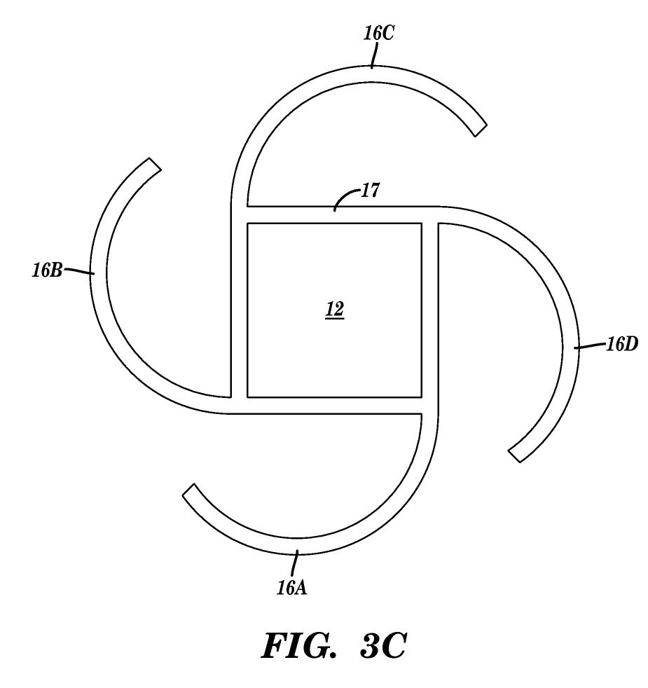

Various other embodiments of an energy harvester system of the present invention is illustrated in FIGS. 5A-C. Specifically, FIG. 5A is an elevational side view of energy harvester system 10, which includes energy harvester device 12, housing 14 comprising internal walls 32 surrounding energy harvester device 12, and flexible supporting structure 16 supporting energy harvester device 12 within housing 14. In this particular embodiment, flexible supporting structure 16 supports energy harvester device 12 from a single side of energy harvester device 12. FIG. 5B is a top view of one particular embodiment of the flexible supporting structure(s) and energy harvester device components of system 10 of FIG. 5A (with housing 14 removed). Two different flexible supporting structures 16A and 16B (or two regions 16A and 16B of a single flexible supporting structure) are shown emanating from only one side of energy harvester device 12 (or a plate-like structure of a flexible supporting structure supporting energy harvester device 12) to attach to a housing. Flexible supporting structures 16A and 16B may be formed as a single unit, with one portion surrounding energy harvester device 12 to support energy harvester device 12 and arms 16A and 16B extending from energy harvester device 12 to connect to a housing. FIG. 5C is a top view of another particular embodiment of flexible supporting structure(s) 16 and energy harvester device 12 of system 10 of FIG. 5A (with housing 14 removed). A single flexible supporting structure 16 is shown emanating from one side of energy harvester device 12 to attach to a housing.

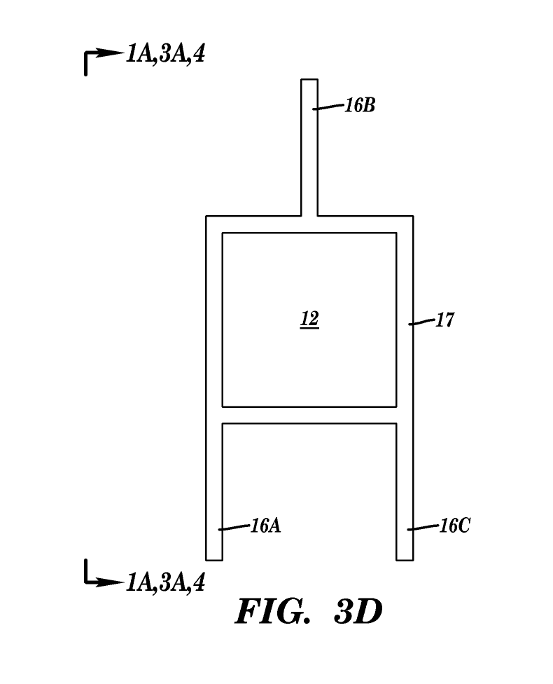

Additional embodiments of an energy harvester system of the present invention are illustrated in FIGS. 6A-D. Specifically, FIG. 6A is an elevational side view of energy harvester system 10, which includes energy harvester device 12, housing 14 comprising internal walls 32 surrounding energy harvester device 12, and flexible supporting structure(s) 16A and 16C supporting energy harvester device 12 within housing 14. In this particular embodiment, energy harvester device 12 is supported by at least two flexible supporting structures (or two regions of a single flexible supporting structure), one above energy harvester device 12 and one below energy harvester device 12. FIG. 6B is a top view of one particular embodiment of the flexible supporting structure(s) and energy harvester device components of energy harvester system 10 of FIG. 6A (with housing 14 removed) showing a single flexible supporting structure 16A attached to the central, upper surface of energy harvester device 12 to attach to a housing. A corresponding flexible supporting structure (or flexible supporting structure region) is located on the lower surface of energy harvester device 12 to attach to the housing, but cannot be seen from the top view of FIG. 6B. FIG. 6C is a top view of another particular embodiment of the flexible supporting structure(s) and energy harvester device components of energy harvester system 10 of FIG. 6A (with housing 14 removed) showing a single flexible supporting structure 16A attached to the upper surface (on one side) of energy harvester device 12 to attach to a housing. A corresponding flexible supporting structure (or flexible supporting structure region) is located on the lower surface of energy harvester device 12 to attach to the housing, but cannot be seen from the top view of FIG. 6C. FIG. 6D is a top view of yet another particular embodiment of the flexible supporting structure(s) and energy harvester device components of energy harvester system 10 of FIG. 6A (with housing 14 removed) showing two flexible supporting structures 16A and 16B (or two regions 16A and 16B of a single flexible supporting structure) attached to opposing sides of energy harvester device 12 to attach to a housing. One of flexible supporting structures (or flexible supporting structure regions) 16A or 16B is attached to the upper surface of energy harvester device 12 and the other flexible supporting structure (or flexible supporting structure regions) 16A or 16B is attached to the lower surface of energy harvester device 12, as best viewed in the elevational, side view of FIG. 6A.

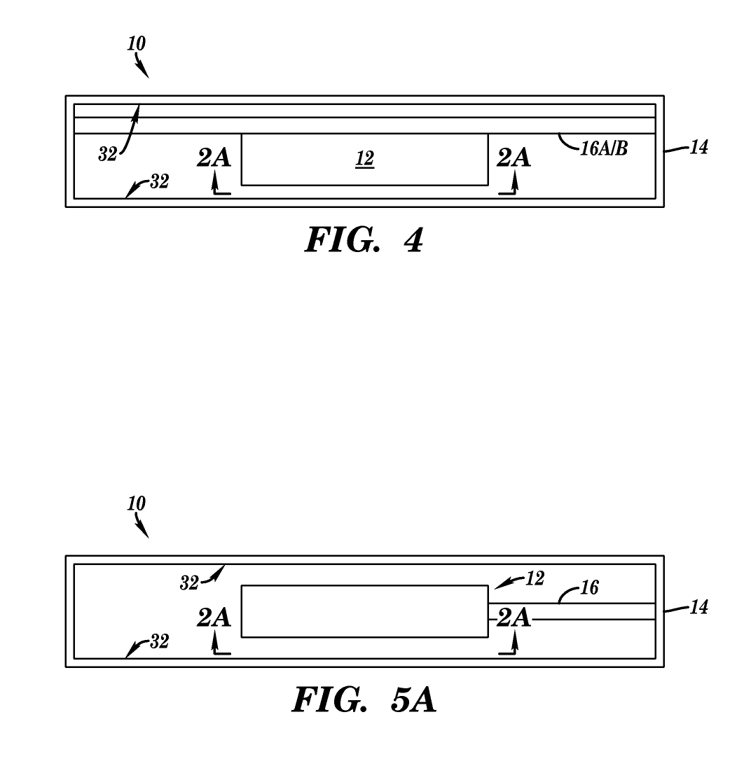

Still other embodiments of an energy harvester system of the present invention are illustrated in FIGS. 7A-D. Specifically, FIG. 7A is an elevational side view of energy harvester system 10, which includes energy harvester device 12, housing 14 comprising internal walls 32 surrounding energy harvester device 12, and visible flexible supporting structure(s) 16A, 16B, 16C, and 16D supporting energy harvester device 12 within housing 14. Energy harvester device 12 is supported by at least four flexible supporting structures 16A, 16B, 16C, and 16D (or four regions 16A, 16B, 16C, and 16D of a single flexible supporting structure), two above energy harvester device 12 (i.e., flexible supporting structures 16A and 16C) and two below energy harvester device 12 (i.e., flexible supporting structures 16B and 16D). FIG. 7B is a top view of one particular embodiment of the flexible supporting structure(s) and energy harvester device components of energy harvester system 10 of FIG. 7A (with housing 14 removed) showing four flexible supporting structures 16A, 16B, 16C, and 16D (or four flexible supporting structure regions 16A, 16B, 16C, and 16D) attached to four corners of the upper surface of energy harvester device 12 to attach to a housing. Corresponding flexible supporting structures (or flexible supporting structure regions) are located on the lower surface of energy harvester device 12 to attach to the housing, but cannot be seen from the top view of FIG. 7B. FIG. 7C is a top view of one particular embodiment of the flexible supporting structure(s) and energy harvester device components of energy harvester system 10 of FIG. 7A (with housing 14 removed) showing three flexible supporting structures 16A, 16B, and 16D (or three flexible supporting structure regions 16A, 16B, and 16D) attached at three different locations of the upper surface of energy harvester device 12 to attach to a housing. Corresponding flexible supporting structures (or flexible supporting structure regions) are located on the lower surface of energy harvester device 12 to attach to the housing, but cannot be seen from the top view of FIG. 7C.

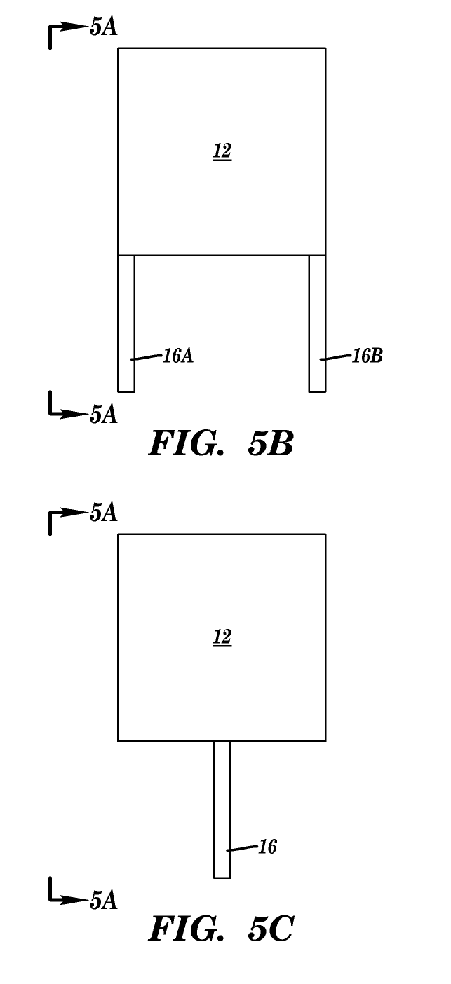

Another embodiment of an energy harvester system of the present invention is illustrated in FIG. 8. Specifically, FIG. 8 is an elevational side view of one embodiment of energy harvester system 10, which includes energy harvester device 12, housing 14 comprising internal walls 32 surrounding energy harvester device 12, and flexible supporting structure 16 supporting energy harvester device 12 within housing 14. In the particular embodiment illustrated in FIG. 8, flexible supporting structure(s) 16 supports energy harvester device 12 from the upper surface of energy harvester device 12 at a location central to at least two opposing sides of energy harvester device 12. Various embodiments of how this may be achieved are illustrated in FIGS. 6B-6D.

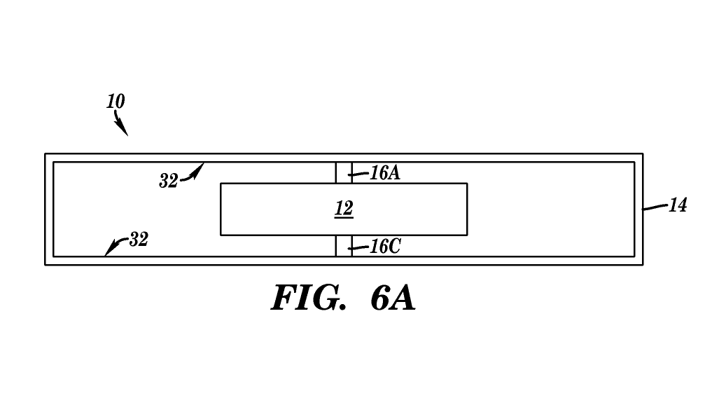

Yet another embodiment of an energy harvester system of the present invention is illustrated in FIG. 9. Specifically, FIG. 9 is an elevational side view of one embodiment of energy harvester system 10 of the present invention, which includes energy harvester device 12, housing 14 comprising internal walls 32 surrounding energy harvester device 12, and flexible supporting structure(s) (or flexible supporting structure regions) 16A and 16B supporting energy harvester device 12 within housing 14. In the particular embodiment illustrated in FIG. 9, flexible supporting structure(s) 16A and 16B support energy harvester device 12 from the upper surface of energy harvester device 12 from at least two opposing sides of energy harvester device 12. Various embodiments of how this may be achieved are illustrated in FIGS. 7B-7C.

While FIGS. 1A-C, 3A-D, 4, 5A-C, 6A-D, 7A-C, 8, and 9 show various embodiments of energy harvester system 10 of the present invention, these embodiments are for illustration purposes only and the present invention is not limited to the specific embodiments illustrated. For example, other designs of flexible supporting structure 16 may also be used to support energy harvester device 12 within housing 14. In addition, energy harvester device 12 may have other designs or configurations. In the present invention, flexible supporting structure 16 supports energy harvester device 12 within housing 14 so that movement of housing 14 causes internal walls 32 of housing 14, or structures connected to internal walls 14, to contact energy harvester device 12. Flexible supporting structure(s) 16 and energy harvester device 12 move within housing 14, further contacting the inner walls of housing 14 at least one time, and more preferably, multiple times, thereby producing energy. Any suitable design that permits flexible supporting structure(s) 16 to support energy harvester device 12 in this manner is encompassed by the present invention.

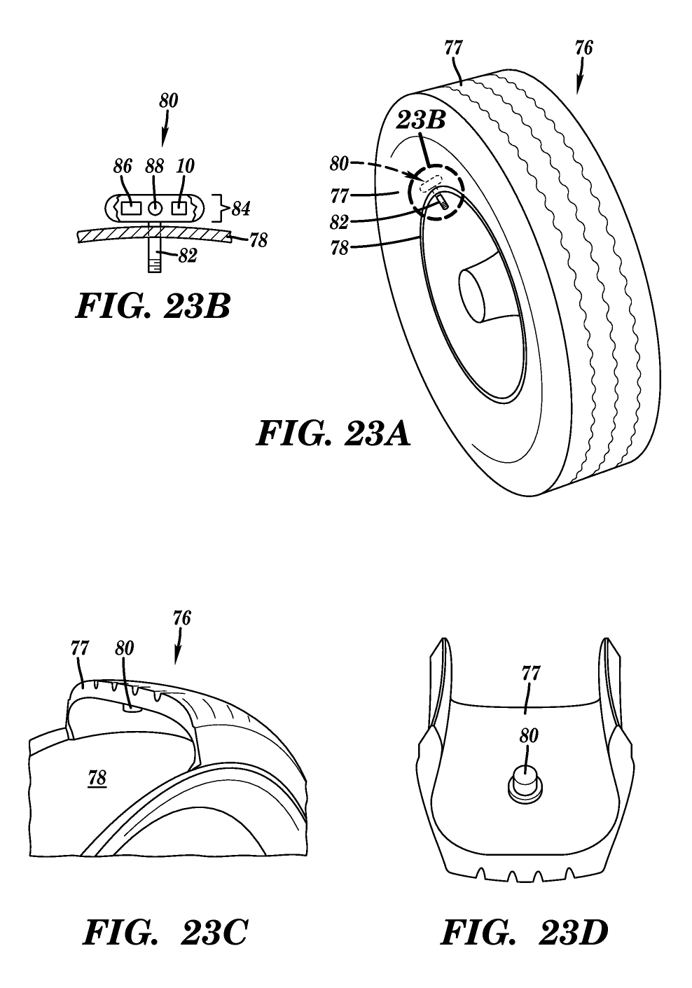

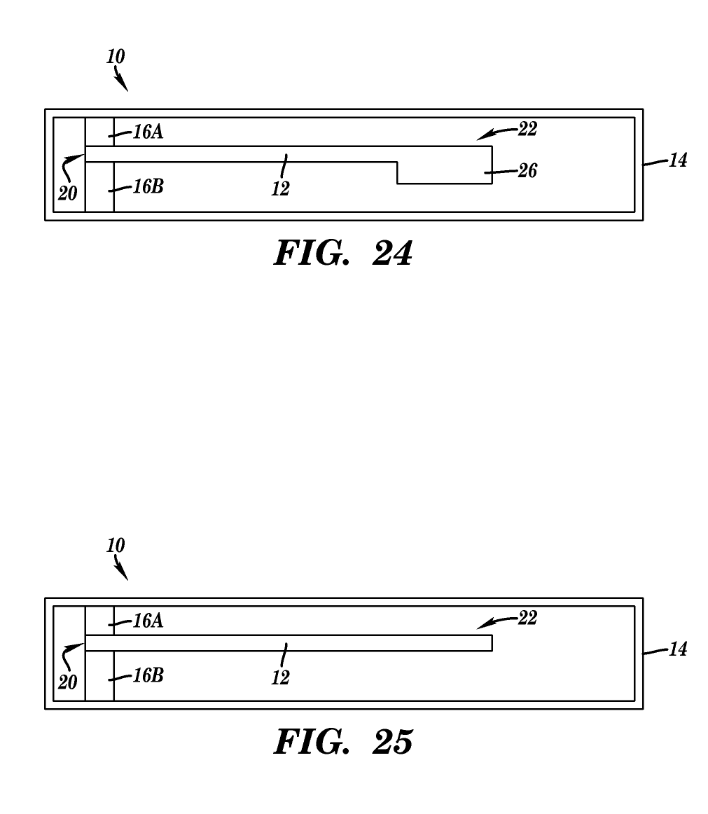

According to one embodiment, energy harvester device 12 according to the illustrations shown, e.g., in FIGS. 6A-D and FIG. 8 is a meso-scale energy harvester device clamped at one end, as described supra, with flexible supporting structure(s) 16 attached, e.g., at the clamped end. Two particular embodiments of an energy harvester system of the present invention employing meso-scale energy harvester devices are illustrated in FIGS. 24 and 25. In particular, energy harvester device 12 is a meso-scale energy harvester device, which is clamped at first end 20. Flexible supporting structures 16A and 16B are attached to meso-scale energy harvester device 12 at first end 20. Energy harvester device 12 is enclosed in housing 14. In the particular embodiment illustrated in FIG. 24, energy harvester device 12 includes integrated mass 26 at second end 22 of meso-scale energy harvester device 12. In the embodiment illustrated in FIG. 25, energy harvester device 12 has no mass. A meso-scale energy harvester device could also be attached to flexible supporting structures as illustrated in FIGS. 5A-C, or according to any other arrangement suitable for operation as described herein.

As illustrated in FIG. 25, it is not necessary that energy harvester device 12 be centered between opposing walls of housing 14 (e.g., between walls above and below energy harvester device 12). While energy harvester device may be centered between opposing walls, it may also be offset and/or positioned so that it is resting against an internal wall of housing 14. When resting against a housing wall, the energy harvester device may move in only a single direction upon receiving an impulse, e.g., away from the housing wall against which it rests.

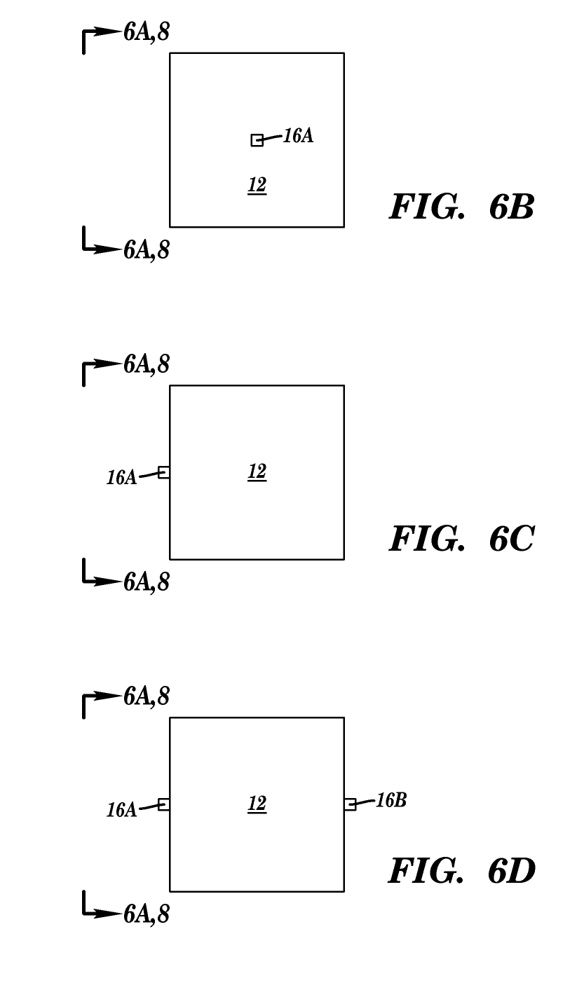

Regarding the operation of the energy harvester system of the present invention, FIGS. 10A-D illustrate one embodiment of this operation. FIGS. 10A-D are elevational side views of one embodiment of energy harvester system 10 of the present invention which illustrate the operation of energy harvester system 10 upon movement of housing 14. Movement of housing 14 caused by external impulse 34 (FIG. 10A) causes internal wall 32A of housing 14 to contact energy harvester device 12 (FIG. 10B). Flexible supporting structure(s) 16A and 16B and energy harvester device 12 move such that energy harvester device 12 contacts internal walls 32A and 32B at least one additional time (FIG. 10C), thereby producing energy in energy harvester device 12. Additional movement of flexible supporting structure(s) 16A and 16B and energy harvester device 12 can result in additional contacts between energy harvester device 12 and internal walls 32A and 32B (FIGS. 10C and 10D), thereby producing additional energy in energy harvester device 12. Accordingly, energy harvester system 10 generates energy through movement from the contacts energy harvester device 12 makes with internal walls 32A and 32B of housing 14 per external impulse 34.

When motion is induced to housing 14 (as represented by arrow 34), energy harvester device 12 moves freely and contacts, e.g., inner wall 32A of housing 14 (e.g., surrounding harvester device 12) (FIGS. 10A and 10B). After this contact, the reaction force F_{R} causes the total mass of energy harvester device 12 to move in a different direction and contact another portion of inner wall 32 of housing 14, e.g., inner wall 32B (FIG. 10C). After this additional contact, the reaction force F_{R} may cause the total mass of energy harvester device 12 to move in another different direction and contact housing 14 again, e.g., at internal wall 32A as illustrated in FIG. 10D. Each contact with inner walls 32 of housing 14 causes the cantilever or resonator beam of energy harvester device 12 (see, e.g., FIGS. 2B-D) to ring, producing power. The sequence of contacts, e.g., as illustrated in FIGS. 10C and 10D, may be repeated several times. This repeated contacting motion within housing 14 produces multiple shock-like inputs to energy harvester device 12 per external input shock to the device (i.e., impulse arrow 34 of FIG. 1 OA), and significantly increases the overall power from the harvester device, thereby maximizing energy produced from energy harvester device 12.

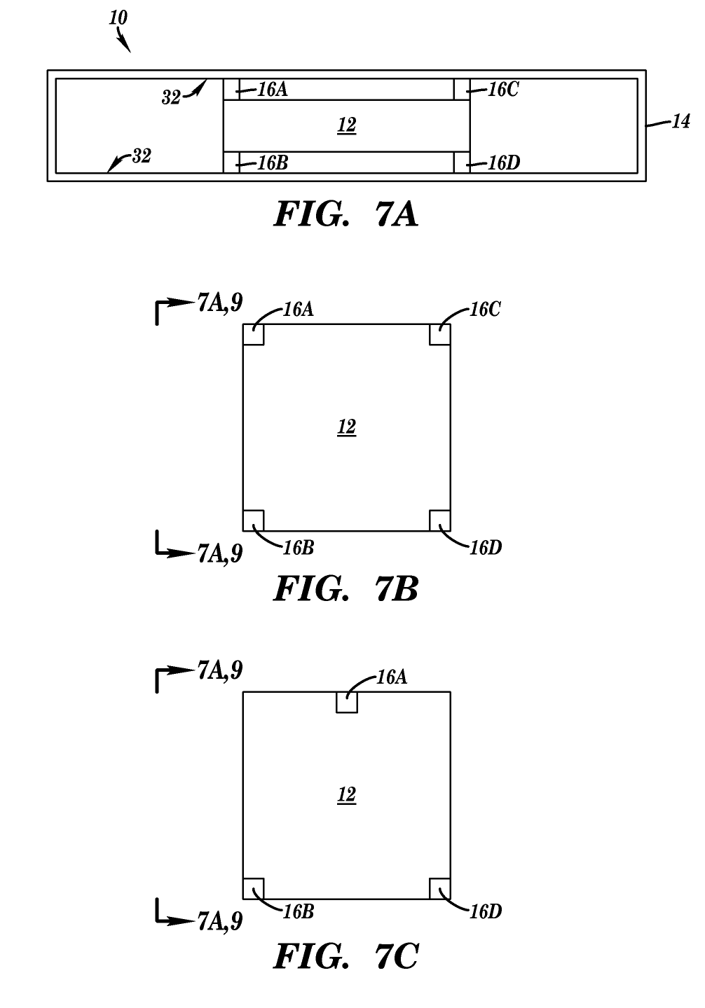

FIG. 11A illustrates the voltage output with time (and, therefore, power output with time) for a single external impact of an energy harvester device, i.e., separate from an energy harvester system as described herein, or not contained in a housing or supported by flexible supporting structures in a system as described herein. As illustrated, movement of such a device by a single external impulse results in a single voltage peak and then electrical ringdown. In contrast, FIG. 11B illustrates the voltage output with time (and, therefore, power output with time) for a single external impact of an energy harvester system of the present invention, in which an energy harvester device is caused to move on flexible supporting structure(s) within a housing to come into contact with inner walls of the housing multiple times (in this case, three additional times). As shown in FIG. 11B, voltage produced from the initial external impulse causes an electrical ringdown profile containing three additional voltage peaks representing three additional contacts between the energy harvester device and the housing containing the energy harvester device (see, e.g., FIGS. 10C and 10D). These multiple voltage peaks create a higher average voltage produced by the system of the present invention compared to the average voltage produced by an energy harvester device not part of the system of the present invention (i.e., an energy harvester device not contained in a housing and/or supported by a flexible supporting structure(s)). Accordingly, the average power generated by the system of the present invention is higher.

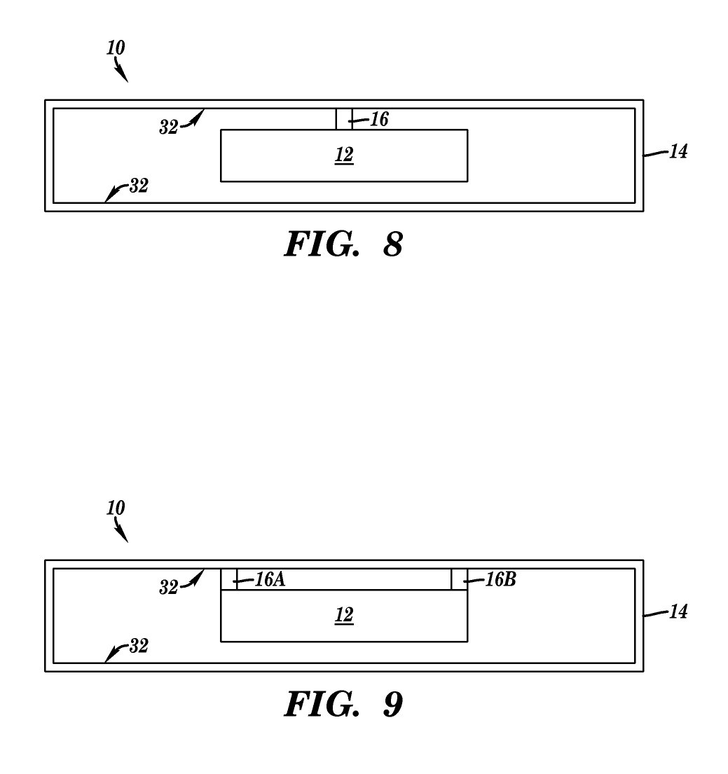

FIGS. 12A-D illustrate another embodiment of the operation of an energy harvester system of the present invention. In particular, FIGS. 12A-D are elevational side views of one embodiment of energy harvester system 10 of the present invention which illustrate the operation of energy harvester system 10 upon movement of housing 14. Movement of housing 14 caused by an external impulse (illustrated by impulse arrow 34 in FIG. 12A) causes structure 36A formed on internal wall 32A of housing 14 to come into contact with energy harvester device 12 (FIG. 12B). A reaction force F_{R} causes flexible supporting structure(s) 16A and 16B and energy harvester device 12 to move in a different direction such that structure 36B comes into contact with energy harvester device 12 (FIG. 12C) to produce energy. Additional movement of flexible supporting structures 16A and 16B and energy harvester device 12 can cause additional contacts between structures 36A/36B and energy harvester device 12 (FIGS. 12C and 12D), thereby producing additional energy.

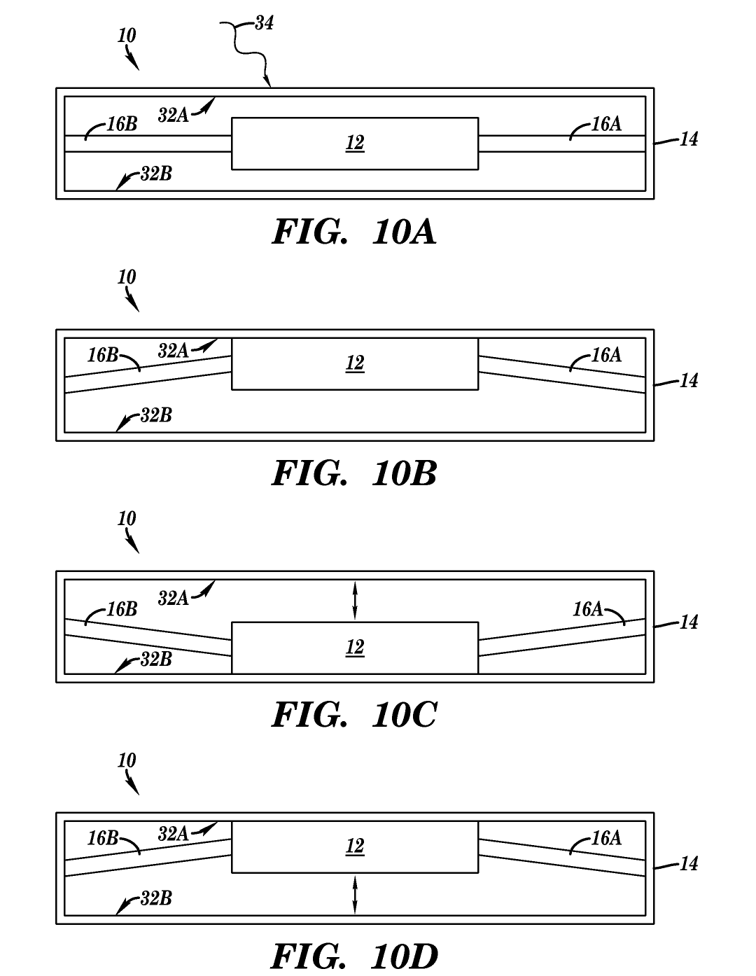

In another variation illustrated in FIGS. 13A-D, energy harvester system 10 of the present invention operates upon movement of housing 14. Movement of housing 14 (illustrated by impulse arrow 34 in FIG. 13A) causes structure 36A formed on energy harvester device 12 to contact inner wall 32A of housing 14 (FIG. 13B). A reaction force F_{R} causes flexible supporting structure(s) 16A and 16B and energy harvester device 12 to move such that structure 36B on energy harvester device 12 comes into contact with inner wall 32B (FIG. 13C) to produce energy. Additional movement of flexible supporting structures 16A and 16B and energy harvester device 12 can cause additional contacts between structures 36A/36B and inner walls 32A/32B (FIGS. 13C and 13D), thereby producing additional energy.

In one embodiment, the air in housing 14 and/or energy harvester device 12 may be evacuated to form a vacuum, thus decreasing the air-resistive damping on the moving structures (i.e., resonator beam 18 of energy harvester device 12, and energy harvester 12 against inner walls 32 of housing 14) to further increase overall energy harvesting efficiency. According to this embodiment, the housing of the energy harvesting system is sealed to the outside atmosphere. Likewise, the base of the energy harvester device may be formed to enclose and seal the resonator beam and mass of the energy harvester device (see, e.g., FIG. 2A).

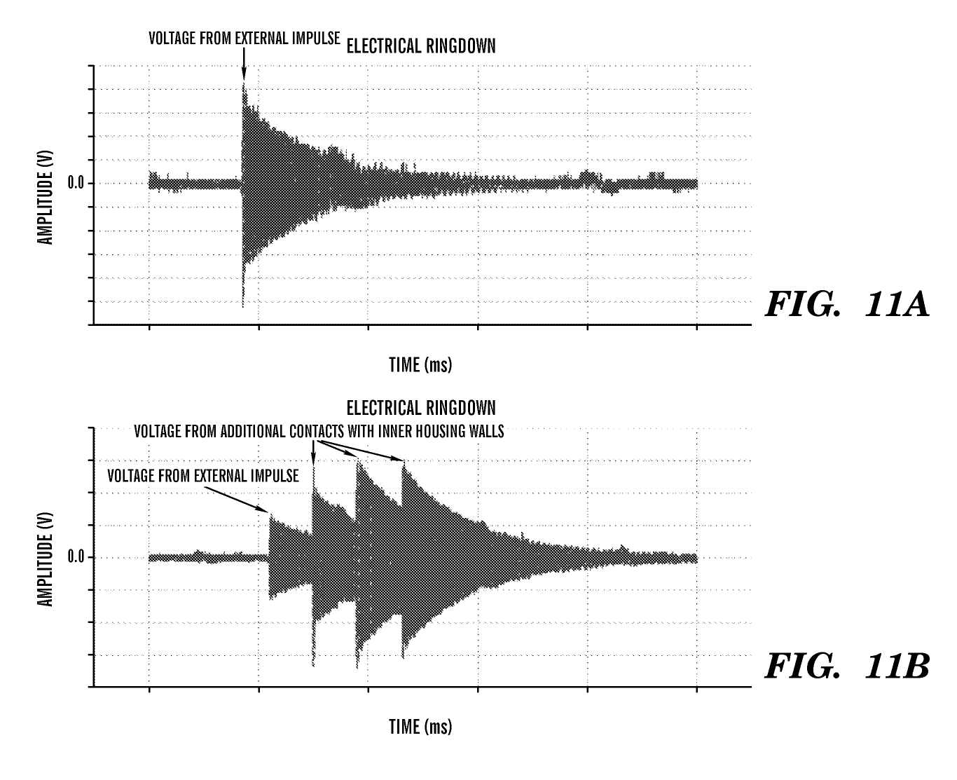

In an alternative embodiment, the housing of the energy harvester system is vented to the outside atmosphere. Likewise, the base (or package enclosure) of the energy harvester device may be formed so as to not fully enclose and seal the resonator beam and mass of the energy harvester device or, alternatively, if the base encloses the resonator beam and mass of the energy harvester device, the base is vented. A vented energy harvester device 12 is illustrated in the top view of energy harvester device 12 in FIG. 14A. As illustrated, energy harvester device 12 has base 24 which encloses resonator beam 18 and mass 26, but is vented with vents 38. A vented housing 14 of the energy harvester system 10 is illustrated in the elevational side view of FIG. 14B. As illustrated, housing 14 encloses energy harvester device 12 and flexible supporting structure(s) 16A and 16B. Vents 38 are formed in a side wall of housing 14. Other side walls, including upper and/or lower walls of housing 14 may also be vented.

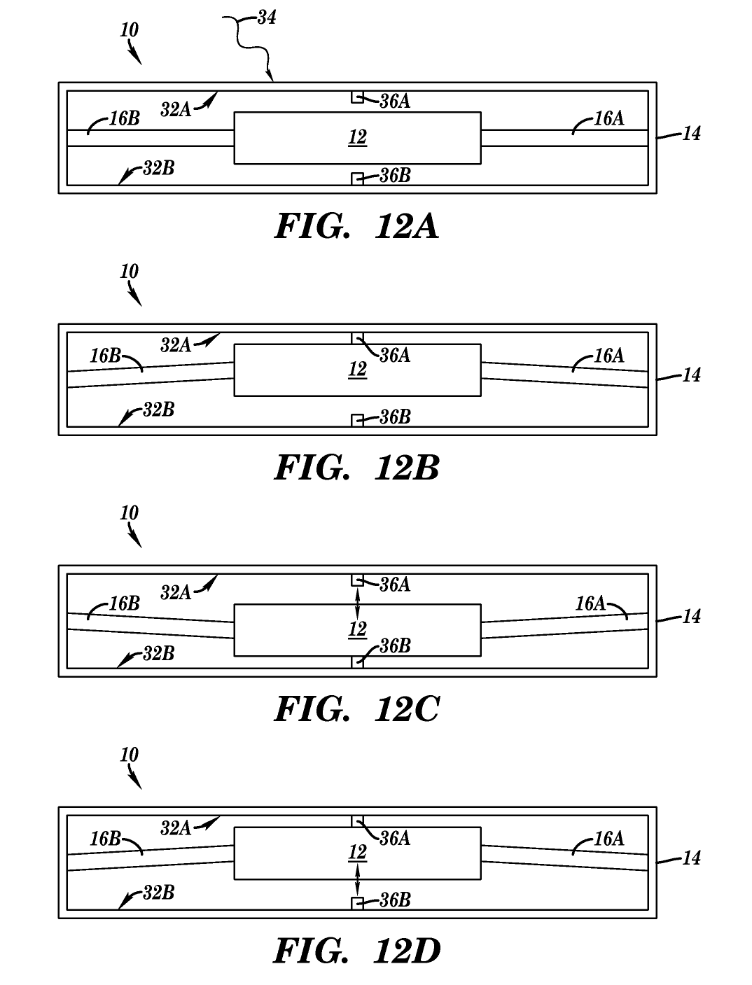

According to one embodiment of the energy harvester system of the present invention, a power converter (e.g., power conversion circuitry) is in electrical connection with the electrical harvesting circuitry to convert energy from the piezoelectric material of the energy harvester device from AC to DC power. One particular embodiment of the energy harvester system is illustrated in FIG. 15. Specifically, FIG. 15 is an elevational side view of one embodiment of energy harvester system 110, in which housing 114 has two distinct chambers, including first chamber 140 in which energy harvester device 112 resides and second chamber 142 in which PCB board 152 resides. PCB board 152 includes power conversion circuitry 154 and electrical harvesting circuitry 130. PCB board 152 is in electrically connection with energy harvester device 112. Specifically, electrical wires 146 connect the piezoelectrical material of energy harvester device 112 to support plate 148 containing electrical traces, for example, a ceramic or plastic support plate with gold traces. Support plate 148 is in electrical connection with energy harvesting circuitry 130 via electrical wires 150. Energy harvesting circuitry 130 and power conversion circuitry 154 are electrically connected to each other e.g., via traces formed on PCB board 152. In addition, energy harvesting circuitry 130 and power conversion circuitry 154 are electrically connected to PCB board 152. According to the particular electrical arrangement illustrated in FIG. 15, electrical energy in the form of AC voltage is generated by energy harvester device 112 and travels to traces on support plate 148 and then to electrical wires 150 which are connected to PCB board 152 at energy harvesting circuitry 130. AC power is then converted to DC power at power conversion circuitry 154. Power then travels from PCB board 152 (electrically connected to power conversion circuitry 154) to electrical wire 162, which electrically connects PCB board 152 to energy storage device 158 which, according to one embodiment, is a rechargeable battery, supercap, or bank of capacitors.

In chamber 140, energy harvester system 110 has upper and lower interior walls 132A and 132B, respectively, which come into contact with energy harvester device 112 during operation, as described supra. Specifically, movement of energy harvester system 110 causes flexible supporting structure 116 and energy harvester device 112 to move and energy harvester device 112 comes into contact with upper and lower walls 132A and 132B, respectively, multiple times during movement. In the particular embodiment of energy harvester system 110 illustrated in FIG. 15, chamber 140 is vented with vents 138.

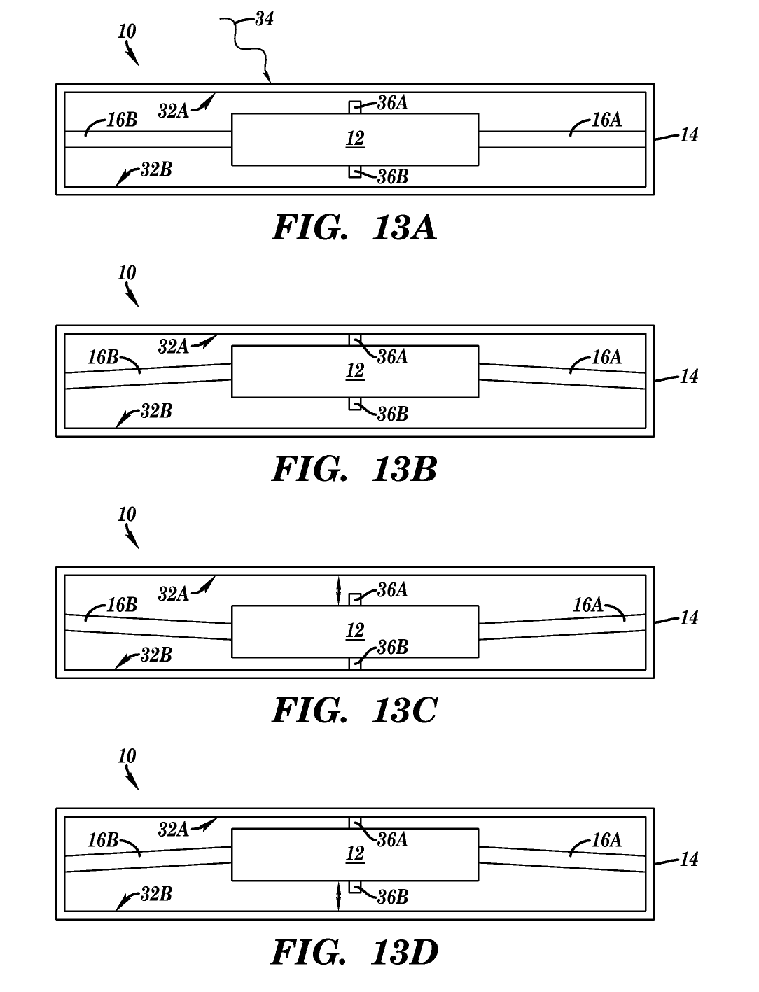

According to another embodiment illustrated in FIG. 16, energy harvester system 10 of the present invention has housing 14 with only a single chamber, in which energy harvester 12 and flexible supporting structure(s) 16A and 16B reside. Housing 14 has inner walls 32. Also illustrated in FIG. 16 are electrical wires 50, which are connected at one end to electrical harvesting circuitry integral to energy harvester device 12 (see items 30 of FIGS. 2C-2D) and exit housing 14 through port 39. The other ends of electrical wires 50 are connectable to a power converter (e.g., power conversion circuitry) to convert energy from the piezoelectric material from AC to DC power.

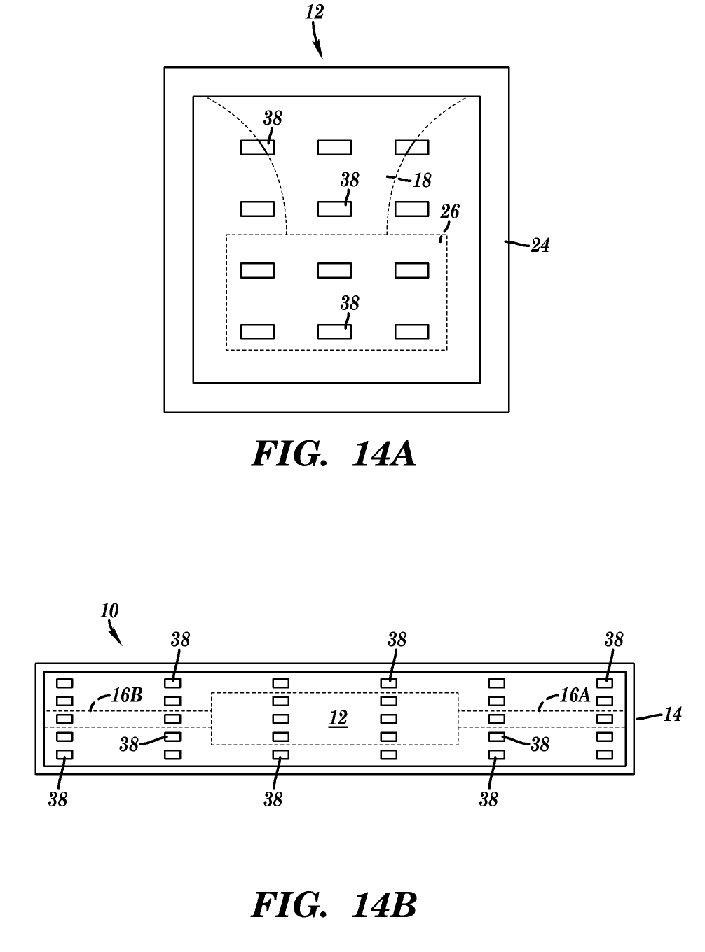

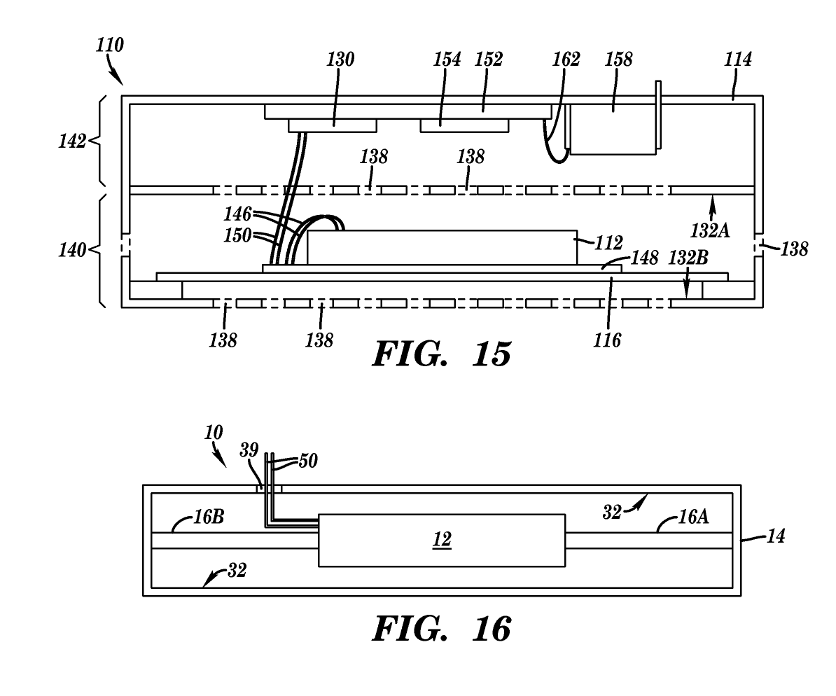

FIGS. 17 and 18 illustrate alternative embodiments of energy harvester system 10 of the present invention, in which energy harvester device 12 is formed integral with a board (e.g., PCB board 52) containing energy harvesting circuitry. This entire integrated unit can then be supported by a flexible supporting structure(s) attached to internal walls of a housing, as described herein. In FIG. 17, electrical wires 50 electrically connect energy harvesting device 12 to energy harvesting circuitry 30. Energy harvesting circuitry 30 is in electrical connection with PCB board 52 and power conversion circuitry 54 (e.g., via leads formed on PCB board 52). Power conversion circuitry 54 receives AC power from energy harvesting circuitry 30 and converts it to DC power. DC power is then supplied to an object being powered by energy harvester system 10 via electrical wires 62. Alternatively, DC power is supplied to an energy storage device. In FIG. 18, the energy harvesting circuitry of energy harvester device 12 is directly coupled to power converter 52. Electrical wires 50 connect the piezoelectric material of energy harvester device 12 to PCB board 52. Electrical wires 61 make energy harvester system 10 connectable to an object to be powered (or to an energy storage device) by conditioned DC power.

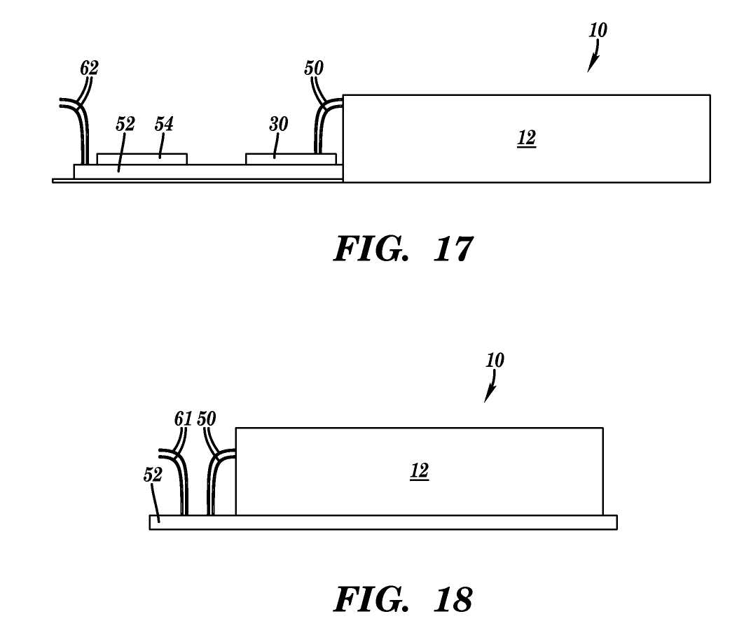

FIG. 19 is an exploded view of a power cell containing one embodiment of an energy harvester system of the present invention. According to this particular embodiment, the housing of the energy harvester system is formed by upper impact housing component 266 and lower impact housing component 262. Between upper impact housing component 266 and lower impact housing component 262 are flexible supporting structure 216, ceramic tray 264 that optionally contains conductive traces, and energy harvester device 212, which rests on ceramic tray 264 and flexible supporting structure 216. During operation, when power cell 210 is subject to movement, energy harvester 212 will “bounce” around on flexible supporting structure 216 and will strike upper impact housing component 266 and lower impact housing component 262 at least one additional time, and more preferably, multiple times.

To adjust the operation of the power cell, lower impact housing component 262 and/or upper impact housing component 266 may be adjusted in size and/or thickness, or screws or bolts may be used to adjust the gap width between these two components and flexible supporting structure 216 located between them.

As also illustrated in FIG. 19, power cell 210 also includes energy storage unit (e.g., battery, supercap, bank of capacitors, or thin film battery such as those made by Cymbet Corporation) 268 and AC-DC conversion board 270 with voltage regulation and optional flashing LED circuitry to indicate the power being generated by energy harvester device 212. Both energy storage unit 268 and AC-DC conversion board 270 are in electrical connection with energy harvester device 212. Top cover 272 is also illustrated.

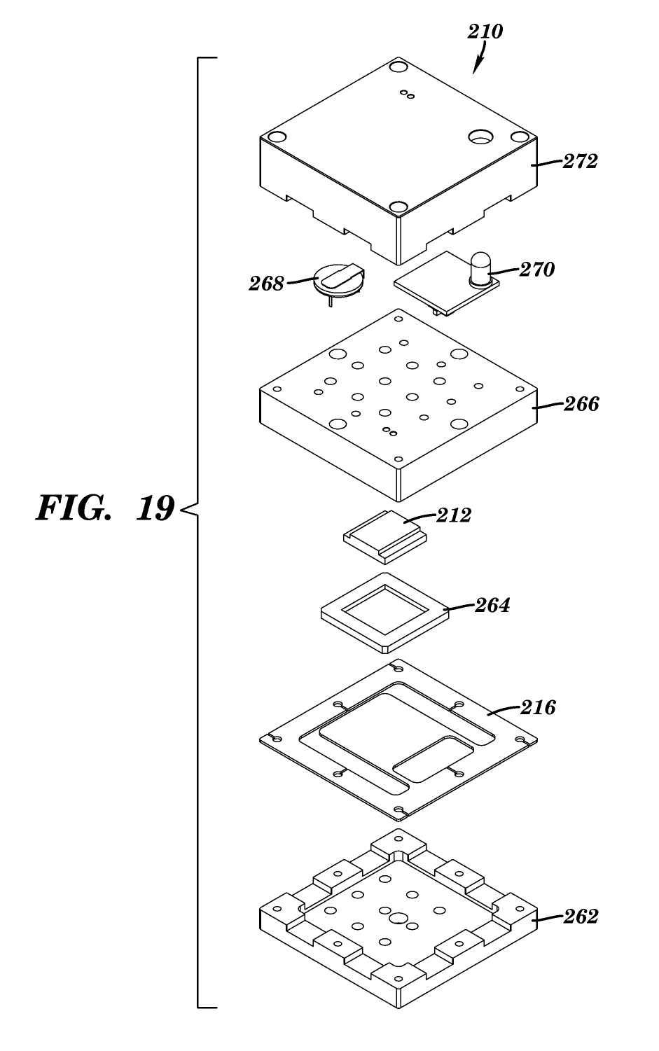

FIG. 20 is a perspective view of some of the components shown in FIG. 19, which are assembled. Specifically, FIG. 20 shows the assembly of lower impact housing component 262, flexible supporting structure 216, ceramic tray 264, and energy harvester device 212.

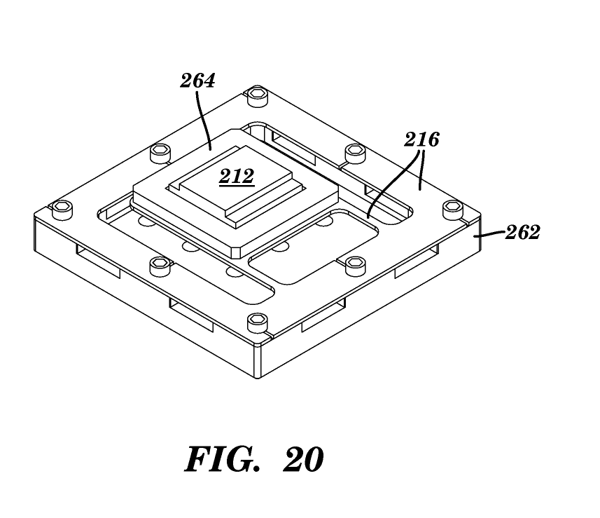

FIG. 21 is a perspective view of a completely assembled power cell, as shown in FIG. 19. Visible are lower impact housing component 262, flexible supporting structure 216, upper impact housing component 266, flashing LED connected to conversion board 270, and top cover 272.

Another aspect of the present invention relates to a system comprising an electrically powered apparatus and the energy harvester system of the present invention electrically coupled to the apparatus.

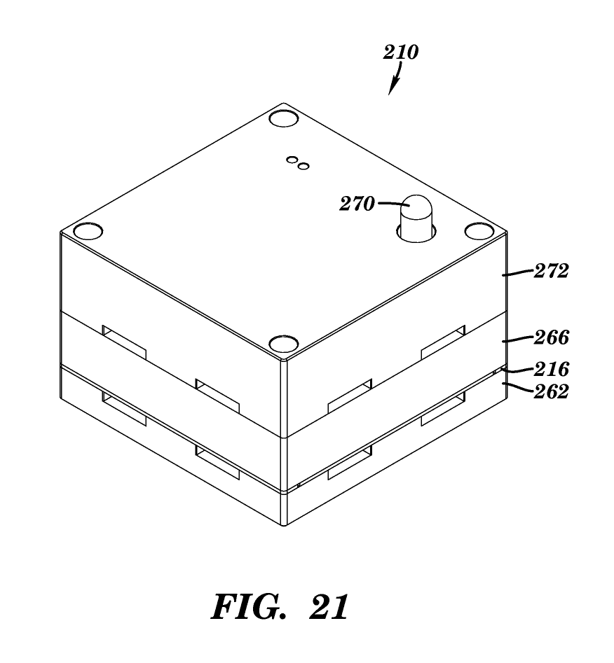

Turning now to FIG. 22, electrically powered apparatus (smartphone) 74 is shown to contain (within its exterior housing) energy harvester system 10 of the present invention. According to this embodiment, energy harvester system 10 provides a standalone source of energy to power smartphone 74, which is used in place of, or in conjunction with, another standalone energy source (e.g., a battery).

In an alternative embodiment, the electrically powered apparatus is, e.g., a wearable device, such as a wrist watch-type device or necklace that electronically communicates with a tablet, PC, and/or smartphone.

The energy harvester system of the present invention may also power an electrically powered apparatus by charging a battery associated with the electrically powered apparatus. For example, the energy harvester system may provide a trickle charge to a coin cell rechargeable battery which powers the electrically powered apparatus. The energy harvester system may also trickle charge a thin film battery such as those made by Cymbet Corporation. The energy harvester system may also supply energy for storage in a supercap or bank of capacitors.

Other systems of the present invention that include an electrically powered apparatus and the energy harvester system of the present invention include, without limitation, a laptop computer; a tablet computer; a cell phone; an e-reader; an MP3 player; a telephony headset; headphones; a router; a gaming device; a gaming controller; a mobile internet adapter; a camera; wireless sensors; wearable sensors that communicate with tablets, PCs, and/or smartphones; wireless sensor motes (for networks monitoring industrial, rail, buildings, agriculture, etc.); tire pressure sensor monitors; electronic displays (e.g., on power tools); agriculture devices for monitoring livestock; medical devices; human body monitoring devices; and toys.

For example, according to one embodiment, the system of the present invention is a wireless sensor device containing a sensor to monitor, e.g., any one or more various environmental properties (temperature, humidity, light, sound, vibration, wind, movement, etc.). The energy harvester system of the present invention is coupled to the sensor to provide power to the sensor.

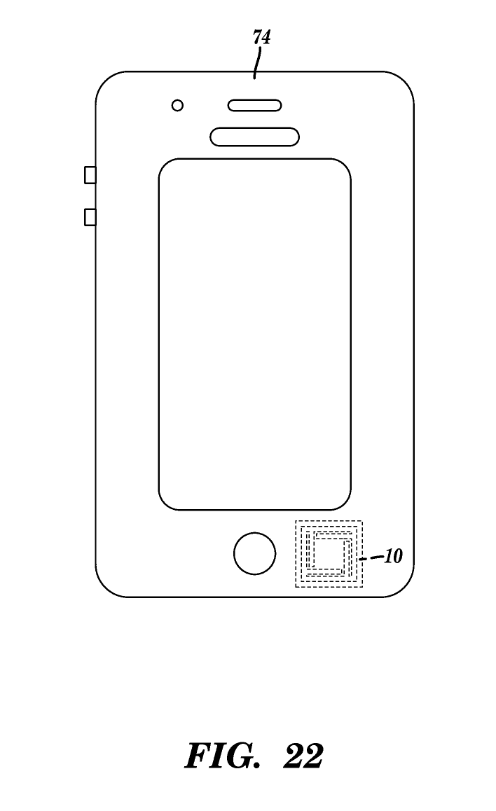

According to one example, the system of the present invention is a tire-pressure monitoring system (“TPMS”) containing a sensor to monitor tire pressure. The energy harvester system of the present invention is coupled to the sensor to provide power to the sensor. As illustrated in FIGS. 23A-B, system 76 includes TPMS system 80 connected to valve stem 82. In the particular embodiment illustrated in FIGS. 23A-B, TPMS system 80 is connected to stem 82 and is mounted directly to wheel rim 78 (i.e., inside or underneath tire 77). In FIG. 23B, various components of TPMS system 80 are illustrated, including sensor component 86, energy storage (battery, supercap, or bank of capacitors) 88, and energy harvester system 10 of the present invention, all of which are in electrical connection and are formed in housing 84 connected to stem 82.

When TPMS system 80 is connected to valve stem 82 near wheel rim 78, energy is generated by energy harvester system 10 during normal vibration from the tire traveling along the road. In addition, system 80 will receive impulses or shocks due to imperfections, bumps, pot-holes, etc., in the road, and these impulses or shocks will cause movement of energy harvester system 10 sufficient to generate an electrical ringdown profile as illustrated in FIG. 11B.

In an alternative embodiment illustrated in FIGS. 23C and 23D, system 76 involves mounting TPMS system 80 to the tread on the inside of tire 77 (i.e., under or embedded in the tread and between the tread and wheel rim 78). When TPMS system 80 is mounted directly to the tire tread (i.e., instead of valve stem 82), energy is likewise generated by energy harvester system 10 during normal vibration from the tire traveling along the road. In addition, system 80 will receive impulses or shocks due to imperfections, bumps, pot-holes, etc., in the road, and these impulses or shocks will cause movement of energy harvester system 10 sufficient to generate an electrical ringdown profile as illustrated in FIG. 11B. An additional source of impulses will occur on the tire-mounted TPMS system as the tire enters the footprint region of rotation (i.e., as tire 77 meets the road at the point where system 80 is attached to tire 77).

A further aspect of the present invention relates to a method of powering an electrically powered apparatus. This method involves providing the energy harvester system of the present invention. The energy harvester system is subjected to movement to generate electrical energy from the piezoelectric material. The electrical energy is transferred from the piezoelectric material to the electrically powered apparatus to provide power to the apparatus.

### EXAMPLES

The following examples are provided to illustrate embodiments of the present invention but are by no means intended to limit its scope.

### Example 1

### Power Output of an Internal Vibration Impulsed Broadband Excitation Energy Harvester System

An energy harvester device having a resonator beam with a frequency of 600 Hz experienced an impulse of 18.5 G with a 1 ms base width. The resulting DC power output was 1 μW. The same energy harvester device was then put into a housing comprising internal walls surrounding at least a portion of the energy harvester device. A metal spring supported the energy harvester device within the housing. The system was subjected to the same impulse (18.5 G), causing the internal walls of the housing to contact the energy harvester device multiple times and the resulting DC power output observed was 9 μW.

Although various embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. An energy harvester system comprising:
an energy harvester device comprising an elongate resonator beam comprising a piezoelectric material, said resonator beam extending between first and second ends;
a housing comprising internal walls surrounding at least a portion of the energy harvester device; and
a flexible supporting structure supporting the energy harvester device within said housing, wherein movement of the housing causes its internal walls or structures connected to its internal walls to contact the energy harvester device, whereby the flexible supporting structure and the energy harvester device move such that the energy harvester device contacts the internal walls or structures connected to the internal walls at least one additional time, thereby producing energy.

2. The energy harvester system according to claim 1, wherein the resonator beam comprises a laminate formed of a plurality of layers.

3. The energy harvester system according to claim 1, wherein the flexible supporting structure comprises a material selected from the group consisting of metal, aluminum, steel, injection molded plastic, elastomer, plastic film, ceramic, glass, silicon-based material, and mixtures thereof.

4. The energy harvester system according to claim 1 further comprising:
one or more electrodes in electrical contact with said piezoelectric material.

5. The energy harvester system according to claim 4 further comprising:
electrical harvesting circuitry in electrical connection with the one or more electrodes to harvest electrical energy from said piezoelectric material.

6. The energy harvester system according to claim 4 further comprising:
a power converter in electrical connection with the one or more electrodes to convert energy from the piezoelectric material from AC to DC power.

7. The energy harvester system according to claim 1, wherein the flexible supporting structure is connected to one or more lateral edges of the energy harvester device at between one and six locations on the one or more lateral edges.

8. The energy harvester system according to claim 1, wherein the flexible supporting structure comprises a central plate from which regions of the flexible supporting structure emanate to connect to the housing, wherein the energy harvester device is supported by the central plate.

9. The energy harvester system according to claim 1, wherein the energy harvester device further comprises:
a base connected to the resonator beam at the first end with the second end being freely extending from the base as a cantilever.

10. The energy harvester system according to claim 9 further comprising:
a package surrounding at least a portion of the second end of the resonator beam.

11. The energy harvester system according to claim 10, wherein the package is formed as a single structure with the base.

12. The energy harvester system according to claim 1, wherein the energy harvester device further comprises:
a mass attached to the second end of the resonator beam.

13. The energy harvester system according to claim 1, wherein the housing comprises structures connected to the internal walls and the energy harvester device contacts the structures.

14. The energy harvester system according to claim 1, wherein the flexible supporting structure comprises a first end and a second end, the first end of the flexible supporting structure being attached to the interior walls of the housing and the second end of the flexible supporting structure being attached to an exterior surface of the energy harvester device.

15. The energy harvester system according to claim 1, wherein the housing comprises one or more vent holes in at least one surface of the housing.

16. A system comprising:
an electrically powered apparatus and
the energy harvester system according to claim 1 electrically coupled to the apparatus.

17. The system according to claim 16, wherein the electrically powered apparatus is selected from the group consisting of a laptop computer; a tablet computer; a cell phone; a smart phone; an e-reader; an MP3 player; a telephony headset; headphones; a router; a gaming device; a gaming controller; a mobile internet adapter; a camera; wireless sensors; wireless sensor motes (for networks monitoring industrial, rail, buildings, agriculture, etc.); tire pressure sensor monitors; powering simple displays on power tools; agriculture devices for monitoring livestock; medical devices; human body monitoring devices; and toys.

18. The system according to claim 16, wherein the resonator beam comprises a laminate formed of a plurality of layers.

19. The system according to claim 18, wherein the flexible supporting structure comprises a material selected from the group consisting of metal, aluminum, steel, injection molded plastic, elastomer, plastic film, ceramic, glass, silicon-based material, and mixtures thereof.

20. The system according to claim 16, wherein the energy harvester system further comprises:
one or more electrodes in electrical contact with said piezoelectric material.

21. The system according to claim 20 further comprising:
electrical harvesting circuitry in electrical connection with the one or more electrodes to harvest electrical energy from said piezoelectric material.

22. The system according to claim 20 further comprising:
a power converter in electrical connection with the one or more electrodes to convert energy from the piezoelectric material from AC to DC power.

23. The system according to claim 16, wherein the flexible supporting structure is connected to one or more lateral edges of the energy harvester device at between one and six locations on the one or more lateral edges.

24. The system according to claim 16, wherein the flexible supporting structure comprises a central plate from which regions of the flexible supporting structure emanate to connect to the housing, wherein the energy harvester device is supported by the central plate.

25. The system according to claim 16, wherein the energy harvester device further comprises:
a base connected to the resonator beam at the first end with the second end being freely extending from the base as a cantilever.

26. The system according to claim 25, wherein the energy harvester system further comprises:
a package surrounding at least a portion of the second end of the resonator beam.

27. The system according to claim 26, wherein the package is formed as a single structure with the base.

28. The system according to claim 16, wherein the energy harvester device further comprises:
a mass attached to the second end of the resonator beam.

29. The system according to claim 16, wherein the housing comprises structures connected to the internal walls and the energy harvester device contacts the structures.

30. The system according to claim 16, wherein the flexible supporting structure comprises a first end and a second end, the first end of the flexible supporting structure being attached to the interior walls of the housing and the second end of the flexible supporting structure being attached to an exterior surface of the energy harvester device.

31. The system according to claim 16, wherein the housing comprises one or more vent holes in at least one surface of the housing.

32. A method of powering an electrically powered apparatus, said method comprising:
providing the energy harvester system according to claim 16;
subjecting the system to movement to generate electrical energy from said piezoelectric material; and
transferring said electrical energy from said piezoelectric material to said apparatus to provide power to the apparatus.

33. The method according to claim 32, wherein said apparatus is selected from the group consisting of a laptop computer; a tablet computer; a cell phone; a smart phone; an e-reader; an MP3 player; a telephony headset; headphones; a router; a gaming device; a gaming controller; a mobile internet adapter; a camera; wireless sensors; wireless sensor motes (for networks monitoring industrial, rail, buildings, agriculture, etc.); tire pressure sensor monitors; powering simple displays on power tools; agriculture devices for monitoring livestock; medical devices; human body monitoring devices; and toys.

34. The method according to claim 32, wherein the resonator beam comprises a laminate formed of a plurality of layers.

35. The method according to claim 32, wherein the flexible supporting structure comprises a material selected from the group consisting of metal, aluminum, steel, injection molded plastic, elastomer, plastic film, ceramic, glass, silicon-based material, and mixtures thereof.

36. The method according to claim 32, wherein the energy harvester system further comprises:
one or more electrodes in electrical contact with said piezoelectric material.

37. The method according to claim 36, wherein the energy harvester system further comprises:
electrical harvesting circuitry in electrical connection with the one or more electrodes to harvest electrical energy from said piezoelectric material.

38. The method according to claim 36, wherein the energy harvester system further comprises:
a power converter in electrical connection with the one or more electrodes to convert energy from the piezoelectric material from AC to DC power.

39. The method according to claim 32, wherein the flexible supporting structure is connected to one or more lateral edges of the energy harvester device at between one and six locations on the one or more lateral edges.

40. The method according to claim 32, wherein the flexible supporting structure comprises a central plate from which regions of the flexible supporting structure emanate to connect to the housing, wherein the energy harvester device is supported by the central plate.

41. The method according to claim 32, wherein the energy harvester device further comprises:
a base connected to the resonator beam at the first end with the second end being freely extending from the base as a cantilever.

42. The method according to claim 32, wherein the energy harvester system further comprises:
a package surrounding at least a portion of the second end of the resonator beam.

43. The method according to claim 42, wherein the package is formed as a single structure with the base.

44. The method according to claim 32, wherein the energy harvester device further comprises:
a mass attached to the second end of the resonator beam.

45. The method according to claim 32, wherein the housing comprises structures connected to the internal walls and the energy harvester device contacts the structures.

46. The method according to claim 32, wherein the flexible supporting structure comprises a first end and a second end, the first end of the flexible supporting structure being attached to the interior walls of the housing and the second end of the flexible supporting structure being attached to an exterior surface of the energy harvester device.

47. The method according to claim 32, wherein the housing comprises one or more vent holes in at least one surface of the housing.
